(19) United States
(12) Patent Application Publication
(10) Pub. No.: US 2022/0064913 A1
(43) Pub. Date: Mar. 3, 2022

(54) MULTI-STAGE ADSORPTION-BASED ATMOSPHERIC WATER HARVESTING

(71) Applicant: Massachusetts Institute of Technology, Cambridge, MA (US)

(72) Inventors: Evelyn Wang, Cambridge, MA (US); Alina LaPotin, Cambridge, MA (US); Yang Zhong, Cambridge, MA (US)

(73) Assignee: Massachusetts Institute of Technology, Cambridge, MA (US)

(21) Appl. No.: 17/409,978

(22) Filed: Aug. 24, 2021

Related U.S. Application Data
(60) Provisional application No. 63/072,859, filed on Aug. 31, 2020.

(51) Int. Cl. E03B 3/28; B01D 53/26; B01D 53/28; B01D 53/04; F24F 3/14

(52) U.S. Cl. CPC E03B 3/28; B01D 53/261; B01D 53/28; B01D 2259/40088; F24F 3/1423; B01D 2253/108; B01D 2257/80; B01D 53/0438

(57) ABSTRACT

A water-harvesting system can operate with a material that can take up and release water with minimum energy requirements and powered by low-grade energy sources, such as sunlight, in order to potentially allow its deployment into households, especially those located in sunny regions. A water-harvesting method and system can include multiple layers of adsorptive material.

### CLAIM OF PRIORITY

This application claims priority to U.S. Provisional Application No. 63/072,859, filed Aug. 31, 2020, which is incorporated by reference in its entirety.

### TECHNICAL FIELD

This invention relates to water-harvesting technology.

### BACKGROUND

Atmospheric water harvesting (AWH) is a strategy which can address the problem of water scarcity, especially in areas with limited infrastructure [1]. Typically, AWH is achieved by either fog harvesting using nets or by cooling the air below the dew point using refrigeration-based dewing systems[2-6]. However, fog harvesting requires the consistent presence of fog (small liquid water droplets in the air at ˜100% relative humidity (RH)), which is location and time-dependent. Dewing systems, on the other hand, may operate at lower RH and/or temperatures but they require significant electrical specific energy consumption (J/L) for refrigeration under such conditions to sensibly cool the air below the dew point. Therefore, existing dewing systems are limited to high RH and temperature regions [7-9].

Adsorption-based AWH uses adsorbent materials to collect water vapor from the air and promises higher thermal efficiencies than traditional, refrigeration-based dewing systems in arid, low RH climates [10]. Systems can be classified into passively regenerated devices operating on a single daily cycle [11, 12], and those operating by multiple cycles per day [13-15] using active auxiliary systems for heating, transport, and condensation. In single daily cycle devices, adsorbents can be regenerated by solar-thermal energy, and condensation can occur at ambient temperatures. Previous works have used metal-organic frameworks (MOF) as the adsorbent materials and successfully demonstrated that by using materials with a step-wise adsorption isotherm, AWH can operate in arid climates (10-40% RH) and desorption can occur at low temperatures under natural sunlight (˜65° C.) [11, 16]. Novel MOFs [12, 13, 16-20], zeolites [21], hydrogels [22-25], and other materials [26-29] have been developed which are promising for AWH applications. However, despite materials advancements, daily water productivity of solar-thermal driven AWH devices remains low due to limitations to heat and mass transport in adsorption processes, various energy losses in the desorption and condensation process, the significant energy requirement for desorption, and the required rejection of the latent heat of condensation (˜2400 kJ/L) in order to condense the water. New strategies are needed to improve the productivity and scalability of solar-thermal AWH.

### SUMMARY

This Summary introduces a selection of concepts in simplified form that are described further below in the Detailed Description. This Summary neither identifies key or essential features, nor limits the scope, of the claimed subject matter.

In one aspect, a water-harvesting system can include a heat absorber, a condenser opposite the solar absorber, and two or more sorbent layers, each having a condenser surface, disposed between the solar absorber and the condenser.

In another aspect, a method of water-harvesting can include absorbing water from ambient atmosphere into a sorbent material, applying energy to an energy absorber to desorb vapor, wherein two or more sorbent layers including the sorbent material and a condenser surface are disposed between the energy absorber and a condenser, and collecting water with the condenser.

In certain circumstances, a gap can be disposed between the two or more adsorbent layers.

In certain circumstances, each of the two or more sorbent layers include a metallic foam and an sorbent material.

In certain circumstances, the sorbent material can include a metal-organic framework, molecular sieve, a silica gel, a zeolite, a carbon fiber, activated carbon, a hygroscopic salt, hydrogel, an adsorbent material, an absorbent material, or combinations thereof.

In certain circumstances, the adsorbent material can include an iron aluminophosphate zeolite.

In certain circumstances, each condenser surface includes metal sheet in thermal contact with a sorbent material.

In certain circumstances, the system can include an enclosure containing the heat absorber, the two or more sorbent layers and the condenser.

In certain circumstances, the enclosure can be opened during dark periods for water adsorption and the enclosure is closed during light periods for water production.

In certain circumstances, a packing porosity of one of the two or more the adsorbent layers is between 0.4 and 0.8.

In certain circumstances, each of the two or more adsorbent layers can have a thickness of less than 30 mm, for example, between 0.5 mm and 30 mm.

In certain circumstances, the system can be powered by solar irradiance, biomass gasification, combustion, or electrically powered joule heating.

In certain circumstances, the method can include dissipating heat from the condenser through a heat sink or active cooling.

In certain circumstances, the method can include applying energy includes supplying solar irradiance, biomass gasification, combustion, or electrically powered joule heating.

In certain circumstances, the method can include dissipating heat from a condenser surface to an adjacent sorbent layer.

In certain circumstances, the two or more adsorbent layers can exchange into the enclosure prior to desorbing water. For example, the adsorbent layers can absorb water outside the enclosure and can be place in the enclosure for water desorption.

In certain circumstances, vapor can move from the adsorbent layer to the condenser following a concentration gradient. The movement can be by diffusion, natural convection, or forced convection.

In certain circumstances, the condensed water can be collected inside the device or it can be drained out and collected exterior to the device.

Recent work has demonstrated adsorption-based solar-thermal-driven atmospheric water harvesting (AWH) in arid regions, but daily water productivity (L/m2/day) of devices remains low. A dual-stage AWH device with optimized transport was developed and tested. By recovering the latent heat of condensation of the top stage and maintaining the required temperature difference between stages, the design enables higher daily water productivity than a single-stage device without auxiliary units for heating or vapor transport. In outdoor experiments, a dual-stage water harvesting device using commercial zeolite (AQSOA Z01) was demonstrated and regeneration under natural, unconcentrated sunlight where ˜0.77 L/m²/day of water was harvested. Modeling showed that by further increasing top-stage temperatures via design modifications, approximately twice the daily productivity of the single-stage configuration can be achieved. This dual-stage device configuration is a promising design approach to achieve high performance, scalable, and low cost solar-thermal driven AWH.

The following Detailed Description references the accompanying drawings which form a part this application, and which show, by way of illustration, specific example implementations. Other implementations may be made without departing from the scope of the disclosure.

### BRIEF DESCRIPTION OF THE DRAWINGS

FIGS. 1A and 1B are schematics of a dual-stage atmospheric water harvesting device.

FIGS. 2A-2D show materials characterization and modeling of efficiency and LMD.

FIGS. 3A-3D depict a dual-stage prototype and experimental setup.

FIGS. 4A-4B depict measured temperatures and water collection during the dual-stage experiment.

FIGS. 5A-5B depict comparisons between modeling and experiment FIG. 6 depicts a model comparison of the single-stage and dual-stage devices and predicted performance improvements.

FIG. 7 depicts an adsorption isotherm of AQSOA Z01.

FIGS. 8A-8B depict fitting an isotherm to calculate a diffusion coefficient and a comparison of diffusion coefficients.

FIGS. 9A-9B depict adsorptions isotherms and the calculation of adsorption enthalpy.

FIG. 10 depicts domains and boundary conditions used in the dual-stage model.

FIGS. 11A-11B depict model results.

FIG. 12 depicts the amount of water harvested from various air gap thicknesses.

FIG. 13 depicts a thermal resistance network.

FIGS. 14A-14C depict fabrication of adsorbent layers.

FIG. 15 depicts a graph of temperature and solar flux during experiments.

FIG. 16 depicts hydrothermal stability tests.

FIG. 17 depicts water quality analysis results.

FIG. 18 depicts data for a single-stage experiment.

FIG. 19 depicts a system as described herein

### DETAILED DESCRIPTION

Reference numbers in brackets “[ ]” herein refer to the corresponding literature listed in the attached Bibliography which forms a part of this Specification, and the literature is incorporated by reference herein.

Water scarcity and access to clean drinking water are critical global challenges. Atmospheric water harvesting (AWH) presents a source for decentralized drinking water supply, particularly where liquid water resources are scarce. In contrast to more conventional methods of AWH, using adsorbent materials can supply drinking water even when the moisture content of the air is low and can be driven by solar-thermal energy. Prior work on solar-driven AWH using adsorbents suffers from low daily water productivity and energy efficiency due to heat and mass transfer limitations and energy requirements in the adsorption and condensation processes. Here, a dual-stage AWH device using commercial zeolite (AQSOA Z01) was developed with optimized thermal and vapor transport where the two stages increase the daily water harvesting productivity and recycle the latent heat of condensation from the top stage to assist in driving desorption of the bottom stage. In outdoor experiments, the dual-stage concept showed a daily water harvesting productivity of ˜0.77 L/m²/day. Modeling showed that the productivity can be further improved to approximately twice the daily productivity of the single-stage configuration by decreasing the heat loss from the solar absorber. This work highlights opportunities for higher capacity water production and opens new pathways towards scalable, lower-cost solar-thermal AWH systems.

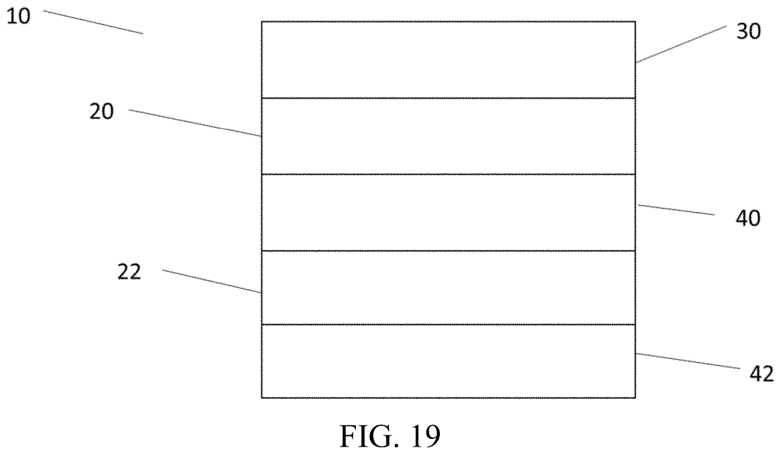

In general, as exemplified in FIG. 19, a water-harvesting system 10 can include two or more sorbent layers 20 and 22 and a condenser 42. Optionally, a second condenser 40 can be located between sorbent layers 20 and 22. The sorbent layers 20, 22 and the condenser 42 can be contained in a housing (not shown). An energy absorber 30, or other heat source, drives the desorption process in the device. Gaps can be present between the sorbent layer and adjacent condenser. A gap can also be present between the energy absorber and the first sorbent layer. The gap can be filled with air, and inert gas, or a vacuum. Gas spaces can be present between sorbent layers and condensers, serves two roles during a water vapor adsorption cycle and a water vapor desorption cycle. During a water vapor adsorption cycle, the gas space contains water vapor, supplied from the ambient environment (i.e., the environment external to the system), that is adsorbed by the adsorbent layer. The gas space in each stage also can serve to provide a necessary temperature gradient between each adsorbent layer and its condenser. The desorption process occurs when this temperature gradient is maintained. An access region can provide access of water vapor (for example, naturally-occurring water vapor in air) by allowing gas exchange between gas space and the ambient environment, such as the atmosphere. Alternatively, simply exposing adsorbent layer to air will be sufficient for vapor adsorption from air. That is taking out sorbent layers from the housing for vapor adsorption from air and install back for desorption. For example, the access region can be a door that opens to the housing or other opening. During a water vapor desorption cycle, the access region is closed to the ambient environment. Irradiation of sorbent layers, for example, by sunlight, can cause the adsorbed water to be released from the sorbent layers and the condensers then condense the water vapor, creating liquid water that can be collected.

More than two sorbent layers can be used, particularly if a heat source temperature is high enough. For example, three stages could be used.

As described herein, during the adsorption step the device can be disassembled and the sorbent layers removed to allow fresh air to flow to the adsorbent. In another embodiment, a door can open (via either human interference or actuated) to open the device to the ambient during the adsorption step. In still other embodiments, the processes can occur continuously in parallel and cyclically. On one half of the device, the solar absorber can be covered and a door can open to allow air to flow to the adsorbent for adsorption. Simultaneously, another section of the device could be in the desorption state with its solar absorber exposed to the sun and its adsorbent isolated from the ambient. The two modes can switch to allow continuous and cyclic water harvesting.

In another embodiment, two sorbent layers can be used and the adsorption and desorption step can occur in series. The adsorption process is much slower than the desorption process. A future iteration can use several extra adsorbent layers which are waiting “charged” in the fully adsorbed state. They can be desorbed in the device and then changed out for charged layers multiple times in a daily cycle.

As described herein, solar thermal energy can be used as the heat input to the top sorbent layer. Other approaches can utilize heat from other sources including biomass gasification, combustion, electrically powered joule heating (electricity can be generated from a solar panel or other sources), or other forms of waste heat. Additionally, optical concentration via mirrors or lenses can be used to increase the temperature of solar heat input. In certain circumstances, the temperature of the adsorbent layer can reach about 90 degrees C. to efficiently desorb water.

As described herein, fans can be used to circulate the air under the condenser fins and reject the heat. Natural convection can be sufficient but is less reliable especially in the unfavorable downward orientation of the condenser fins. In other embodiments, the device can be flipped over so that heat sink fins are on the top of the device which would increase the convective heat transfer coefficient and eliminate the need for the fans. If direct solar heating is used as the heat source, mirrors could be used to direct the sunlight to the solar absorber at the bottom of the device. If other heat sources are used, heat application can be more trivial.

As an alternative to fins, other cooling mechanisms can be used. For example, greater heat transfer coefficient could be achieved by immersing the fins in water (perhaps the water that was harvested) or by burying them in the dirt which would eliminate the need for the fan. Alternatively, active cooling at the condenser can be achieved via vapor compression refrigeration, evaporative cooling, or thermoelectric cooling.

In a larger scale version of this device, more practical approaches can be taken to operating on a continuous cycle with fully active systems. During the adsorption step, fans can be used to bring fresh air to the adsorbent. Then the device would be closed and isolated from the ambient surroundings. During the desorption step, a heat exchanger can exchange heat from a heat source with a heat transfer fluid which would get transported through pipes to a fin/tube heat exchanger. The adsorbent can be coated on the fins of the heat exchanger. Fans can then transport the desorbed vapor to a thermally isolated condenser region which would then reject its condensation heat to a second adsorption bed.

The housing can be made from metal, plastic, glass, or combinations thereof. Condensers or a condenser surface can be made from a conductive metal, such as aluminum, steel, or copper. A cover to reduce convective heat loss can be glass, plexiglass, plastic wrap, clear acrylic, optically transparent aerogel. When the heat source is a solar absorber, it can be a selective surface (highly absorbing in solar spectrum with low emission in thermal spectrum), black paint, graphite coating, or Pyromark paint. For example, the solar absorber can be a conductive metal, such as aluminum, steel, or copper, that is coated with solar absorbing paint/spray (e.g., graphite coating or Pyromark paint).

The adsorbent material can have an affinity to adsorb water vapor and can also absorb a portion of sunlight. In certain circumstances, the adsorbent layer can be a porous adsorbent layer. The adsorbent material can be a zeolite, molecular sieve, metal organic framework (MOF), silica gel, activated carbon, a hygroscopic salt, a hydrogel, or mixtures thereof. The adsorbent material can be held by a binder, for example, a thermally conductive binder. Examples of thermally conductive binders can include metallic foams (aluminum, copper, nickel) or graphite.

The condenser can be a finned heat sink that dissipates heat to the ambient. The condenser surface can be a sheet metal, for example, copper or aluminum. The condenser can include fins, for example, aluminum or copper extruded fins or pin fins.

The device can be insulated to control the internal temperature during the desorption cycle. The insulation can be polyisocyanurate, styrofoam, mineral wool, polyurethane, or polystyrene.

The timing of the water vapor desorption cycle and water vapor adsorption cycle can vary. For example, the water vapor desorption cycle can be during daylight hours and the water vapor adsorption cycle can be during nighttime hours. In this circumstance, the access region can allow gas exchange between naturally-occurring water vapor in air or atmosphere surrounding the housing by opening at or near sundown for the adsorption cycle. The access region can then close for the desorption cycle at or near sunrise. As an alternative, the opening and closing of access region can change based on the amount of sunlight impinging on a surface of the device. In this circumstance access region may close during daylight hours if there is cloud cover that reduces the amount of sunlight contacting the adsorbent layer. In another embodiment, the timing of the cycle is independent of the time of day. In certain circumstances, the timing of the cycle can be irregular. In other circumstances, the timing of the cycle can be periodic on a daily or a semidaily basis. For example, the cycle can be 0.5 hour adsorption and 0.5 hour desorption—24 cycles per day, 1 hour adsorption and 1 hour desorption—12 cycles per day, or 2 hours adsorption and 2 hours desorption—6 cycles per day.

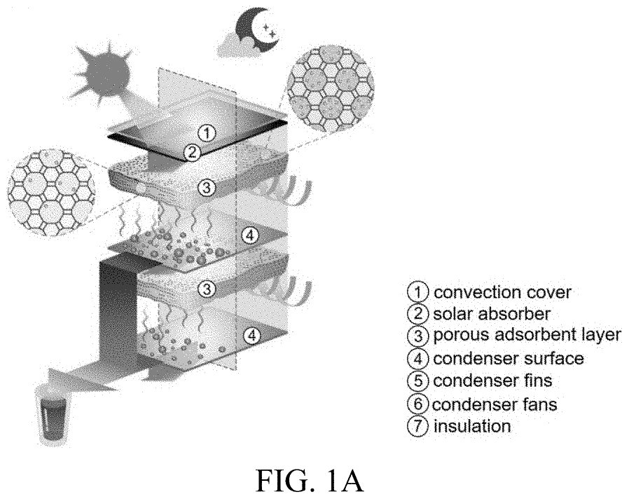

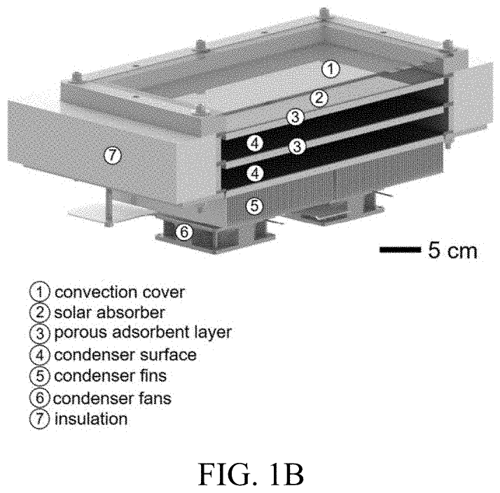

Here, a dual-stage AWH device (FIG. 1A) was introduced as a strategy to improve the water productivity (LIVID) [L/m²/day, defined as liters of water produced per solar absorbing area per day] of single daily cycle devices. This device operates by using two adsorbent layers under a single solar absorber for device heat input and a single condenser for device heat rejection. While the slow kinetics of the adsorption process has limited the LIVID of solar-thermal devices, the dual-stage design uses two optimized layers to achieve higher LMD. The latent heat of condensation from the top stage is recycled and used to assist in desorption of the bottom stage. While the thermal efficiency can also be improved with this approach (as also seen in passive multi-stage solar distillation [30, 31]), the most relevant metric for single daily cycle devices is daily water productivity. LMD is more important because optimizing single daily cycle devices for efficiency does not result in maximum production due to the dependence of desorption rate on the concentration of water vapor in the adsorbent. This metric was a focus given the abundance of solar energy, the potential for its use in AWH devices, and the opportunity to increase productivity by improvements to device design.

Modeling results are presented, which indicate the dual-stage device can improve productivity provided the maximum temperature in the system (temperature of the top stage) is sufficiently high for a given material. Using the results of the model to guide the design, a dual-stage AWH device was fabricated and tested in outdoor experiments in which water was harvested from both stages and condensation occurred at ambient temperatures. By using a material with a step-wise adsorption isotherm and low desorption temperature, it was demonstrated that water can be released from both stages of the device using unconcentrated sunlight by utilizing the full temperature gradient which develops between the solar absorber and the condenser of the bottom stage. The device was exemplified with a commercially available adsorbent material (AQSOA Z01 zeolite), indicating that performance improvements and scalability can be simultaneously achieved using the dual-stage design. Experiments showed 18% greater daily productivity over our single-stage device. The experimentally validated model was used to show that even in arid conditions of 35% RH and 25° C., the dual-stage configuration promises approximately twice the LMD of the single-stage configuration by increasing the temperature of the top stage. The work described herein shows that by using a commercially available adsorbent there is a pathway for scalable solar-thermal AWH devices. The configuration can be used with other adsorbents with more favorable properties, such as a higher uptake and lower energy required for regeneration, to further increase device performance.

The dual-stage concept (FIG. 1A and details of the device shown in FIG. 1B) consists of two adsorbent layers separated by air gaps which create a temperature gradient between the layers. Each layer is composed of the adsorbent material packed inside a porous metal foam, creating a composite layer with enhanced thermal conductivity. The device operates on a daily cycle because it is designed to be regenerated passively by sunlight. During the night, the device is opened, and the two adsorbent layers are exposed to the ambient atmosphere. Water vapor molecules diffuse into the layers and into the pores of the adsorbent. During the day, the adsorbent layers are placed in the device and heated from the top via sunlight received at a solar absorber. A transparent convection cover protects the solar absorber to decrease convective heat loss to the ambient. The device is well-insulated at the side walls so thermal energy conducts from the solar absorber to the top adsorbent layer, through the device, and to the condenser. For both stages, when the temperature of the adsorbent rises, vapor desorption is driven by the temperature gradient between the adsorbent layer and its corresponding condenser due to the low thermal conductivity of air in the gap (˜0.027 W/m/K). In the top stage, vapor is condensed on a copper surface in thermal contact with the bottom adsorbent layer, so the latent heat of condensation is recovered and conducted to the bottom stage. Simultaneously, vapor desorbs from the bottom layer due to the temperature gradient between the bottom layer and its corresponding condenser. Water is collected at each condenser and drained out of the device.

Referring more specifically to FIGS. 1A and 1B, schematics of the dual-stage atmospheric water harvesting device are shown. In FIG. 1A, the dual-stage atmospheric water harvesting concept is depicted. Water vapor diffuses into the adsorption layers (3), filling the pores of the adsorbent when the device is exposed to ambient air during the night. During the day, the device is closed and heated from the top by sunlight received at a solar absorber (2). The temperature and concentration difference which develops between each adsorbent layer (3) and its condenser (4) drives desorption. Desorption of the bottom layer is driven by both the latent heat of condensation from the top stage as well as heat conducted through the device. Referring to FIG. 1B, details of the dual-stage atmospheric water harvesting device prototype are shown. The device consists of two stages (two adsorbent layers separated by air gaps). The back side of the top adsorbent layer is in thermal contact with the solar absorber which is insulated by the transparent convection cover (1). The bottom adsorbent layer is in thermal contact with the condensing surface for the top stage. The condenser for the bottom stage consists of an array of fins (5) cooled by small fans (6) (2.4 W total). The sides of the device can be well-insulated (7). The insulation can be a foam or fiber material.

Device Design and Modeling

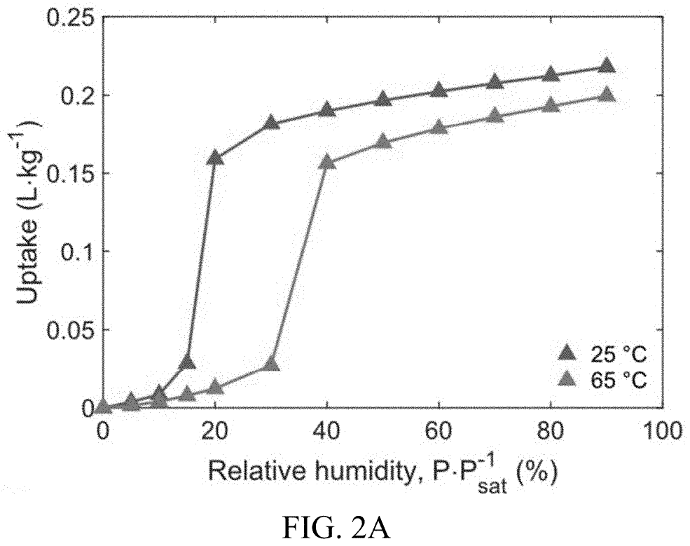

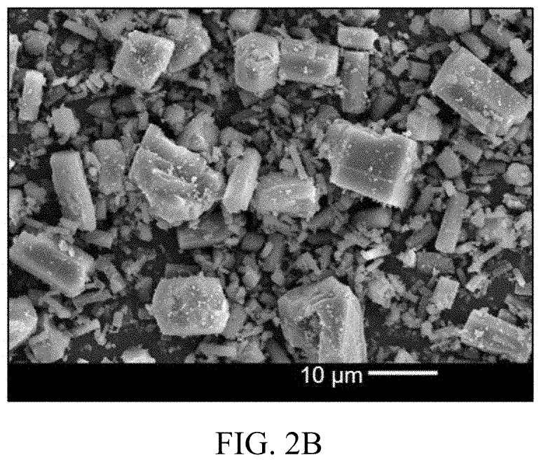

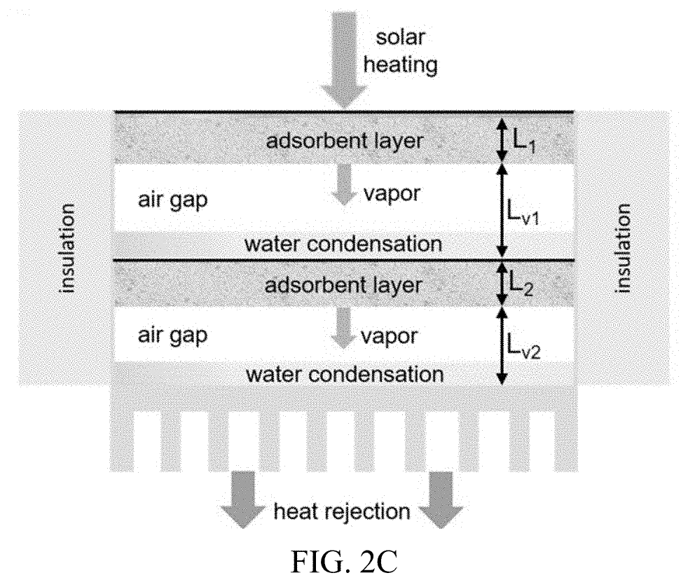

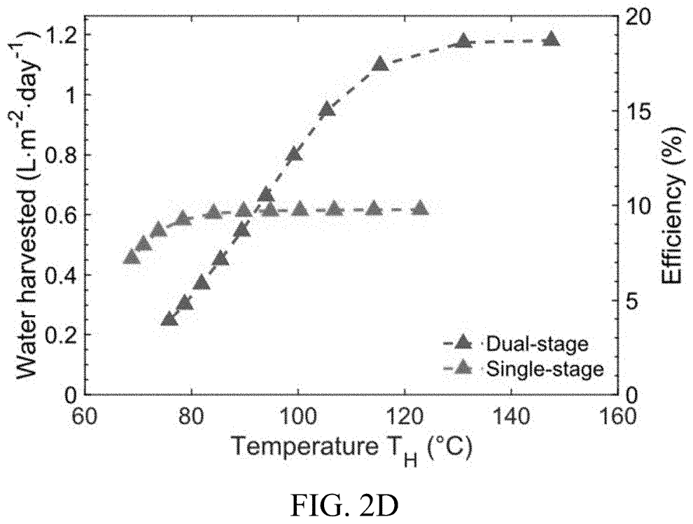

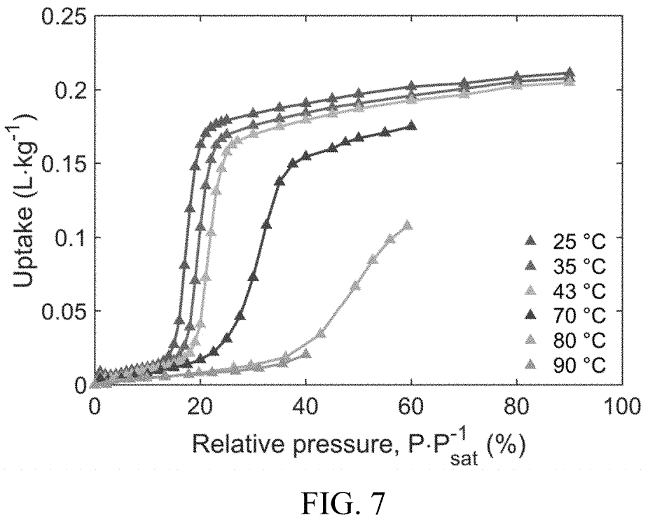

AQSOA Z01 was selected for both modeling and prototype demonstration. AQSOA Z01 is a microporous iron aluminophosphate (framework consisting of AlO₄, PO₄, and FeO₄ tetrahedrons) AFI-type zeolite [32]. AQSOA Z01 was selected because it is available commercially in large quantities, hydrothermally stable, its adsorption enthalpy (˜56 kJ/mol) and desorption temperature (˜60° C. at a condenser temperature of ˜25° C.) are relatively low compared to conventional zeolites, and it exhibits relatively fast vapor kinetics [33, 34]. Additionally, AQSOA Z01 has a favorable stepwise isotherm indicative of uniform pore sizes and leading to a sharp increase in vapor uptake over a small change in RH. This sharp, stepwise isotherm shape and the shift of the step to higher RH with temperature also lead to lower energy requirements for regeneration. The adsorption isotherm was measured in a N₂/vapor environment (at atmospheric pressure) using a sorption analyzer (Q5000, TA), and the equilibrium uptake as a function of RH is shown at 25° C. and 65° C. (FIG. 2A). The isotherms measured in a N₂/vapor environment are representative of conditions for water harvesting from air. Isotherms were also measured in a pure vapor environment (DVS Vacuum, Surface Measurement Systems Ltd.) at a range of temperatures from 25° C. to 90° C. (FIG. 7). The higher temperature isotherms enabled predictions of the dual-stage device performance at temperatures expected by solar heating. The N₂/vapor isotherms were used for all calculations of the kinetics and the adsorption enthalpy.

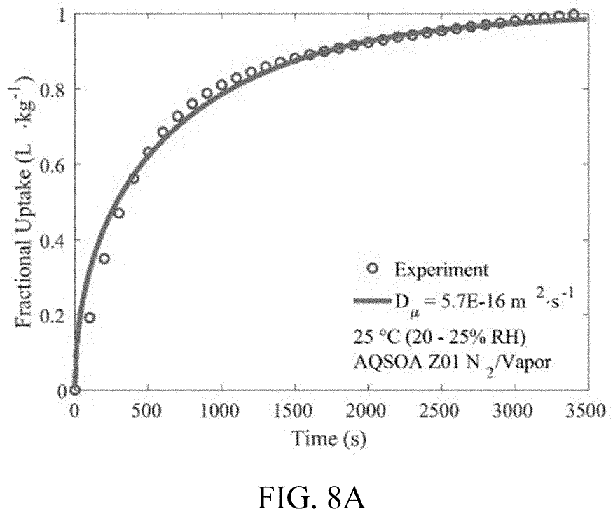

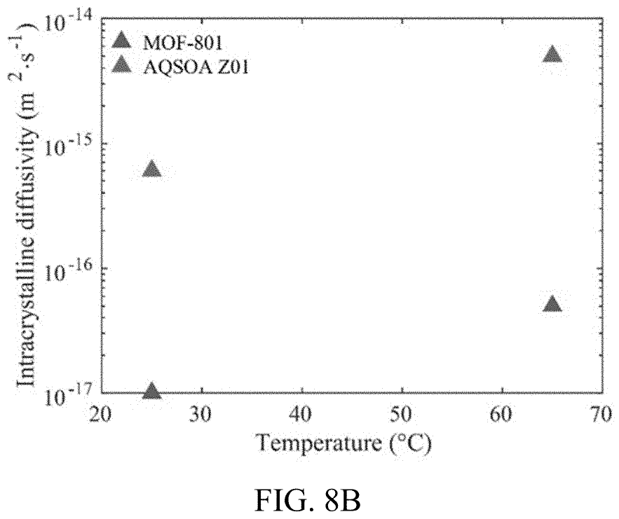

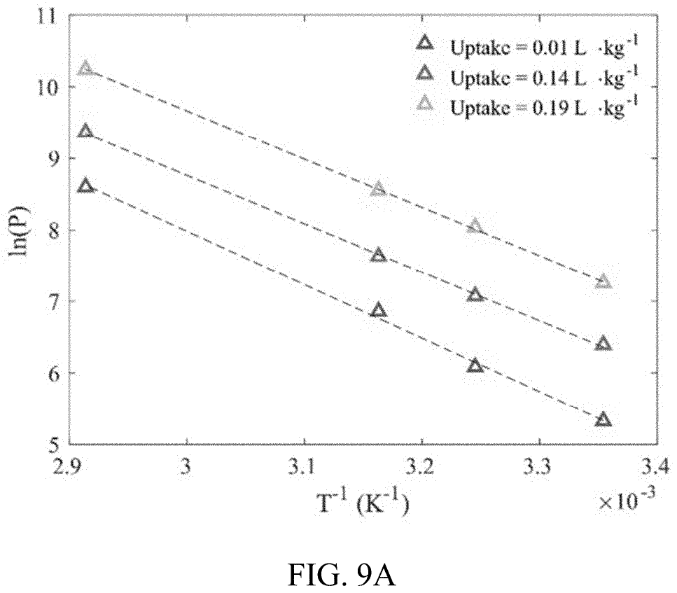

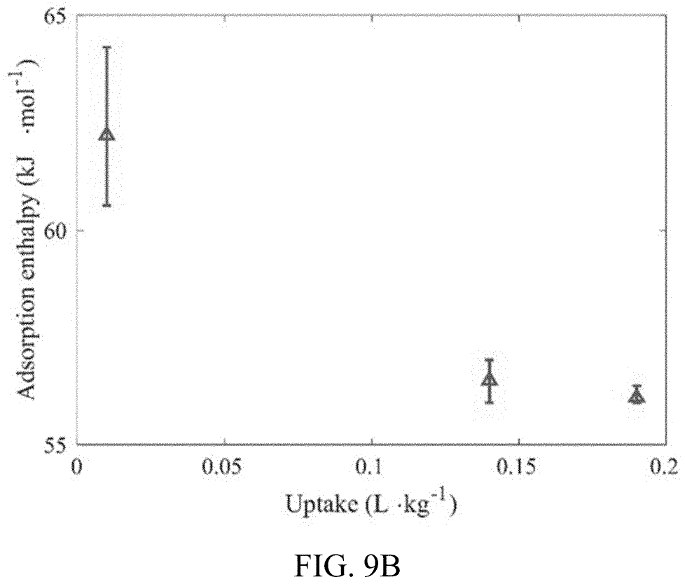

From the isotherm, the intracrystalline diffusion coefficients (diffusion of vapor inside the adsorbent crystals) were extracted at different temperatures (FIGS. 8A-8B) and calculated the adsorption enthalpy (FIGS. 9A-9B). For desorption to occur, the thermal energy input needs to be high enough to both reach the desorption temperature as indicated by the adsorption isotherm and overcome the adsorption enthalpy which is endothermic during desorption. The crystal size varies, but literature values range from 5-8 μm, which matched the observed size of our sample (FIG. 2B) [34]. From a device perspective, when a material with a stepwise isotherm is used, the temperature difference between each adsorbent layer and its condenser must be sufficient to bring the equilibrium uptake below the steep step in the isotherm. The greater the temperature difference that exists between the adsorbent layer and condenser, the larger the driving force there is for desorption. Based on the isotherms for our AQSOA Z01 sample (FIG. 2A and FIG. 7), desorption can occur at ˜60° C. if the condenser is at ˜25° C., and at ˜90° C. if the condenser is at ˜60° C., although desorption rate increases with the temperature difference between the adsorbent and the condenser. The required temperature differences (˜30° C.) and the temperatures achievable by solar-thermal energy without concentration (˜100° C.) limit the focus of this work to a maximum of two stages.

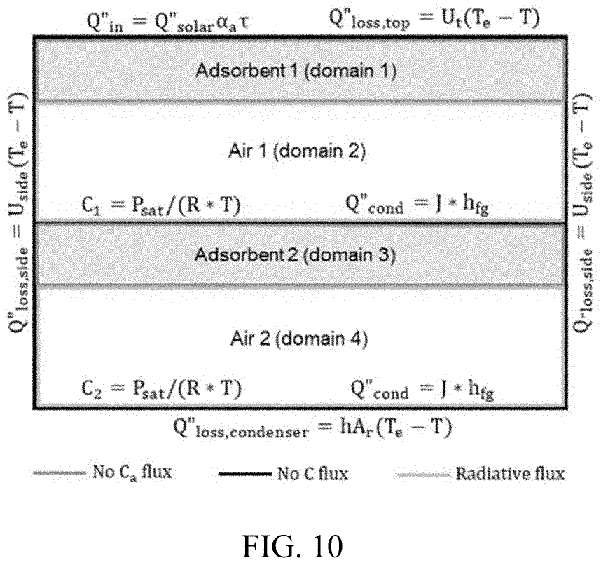

A model of the device was developed using the measured AQSOA Z01 material properties to guide design decisions and predict the performance improvements which can be achieved using the dual-stage configuration. This model framework leverages the developed and experimentally validated modeling approach we have used previously to describe heat and mass transport in composite adsorbent layers [11, 16, 35, 36]. The model equations and boundary conditions are described below. The governing mass transfer equation includes vapor diffusion in the adsorbent layers and air gaps and the linear driving force model for vapor diffusion inside the adsorbent crystals. The governing heat transfer equation captures the latent heat due to the adsorption enthalpy, transient heat conduction in the adsorbent layers, and radiative heat transfer across the air gaps. The heat flux boundary conditions (FIG. 10) include the solar energy absorbed at the solar absorber, heat loss from the top and sidewalls of the device, the heat rejection at the finned condenser, and the latent heat of condensation at each condenser surface. Calculations for the combined top heat transfer coefficient, Uₜ, which include convective and radiative heat loss from a selective solar absorber at the top of the device to the environment can be found below.

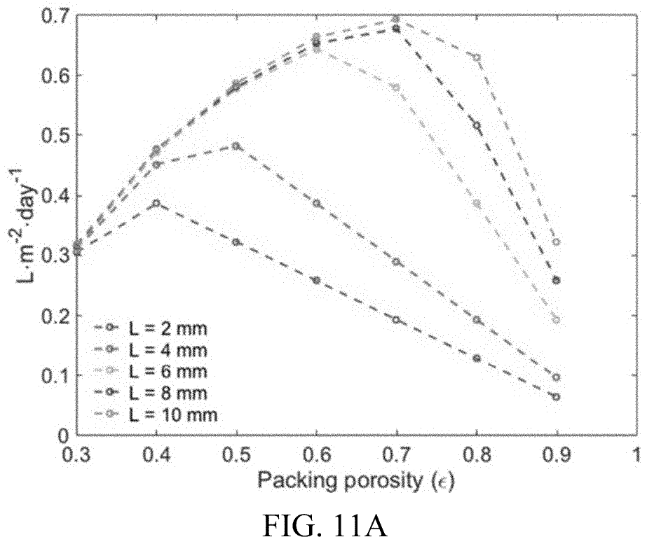

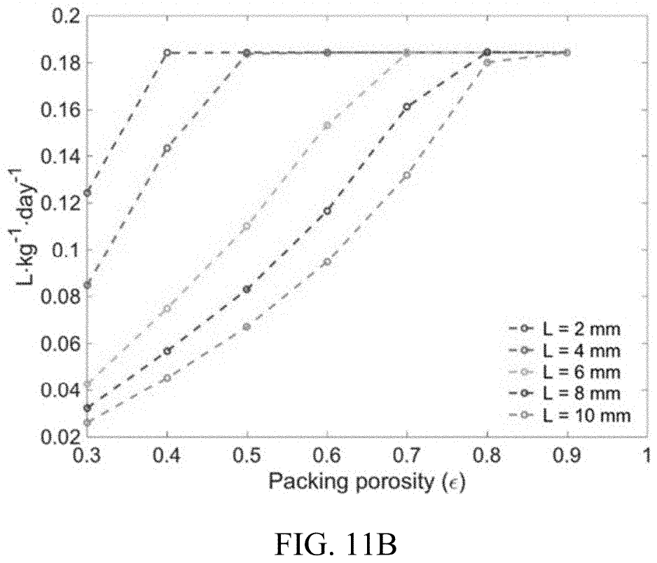

FIG. 2C shows the geometry that was optimized using the model—the layer thicknesses (L₁ and L₂) and the air gap thicknesses (Lᵥ₁ and Lᵥ₂). The adsorption process was modeled in the layers to optimize the layer thickness and packing porosity to balance the metrics of LMD and L/kg/day (FIGS. 11A-11B). Using our model, we showed that increasing the adsorbent layer thickness in a single-stage configuration to increase the daily capacity is not effective due to kinetic limitations. For daily cycle operation, there is an upper limit on layer thickness which justifies the choice of the dual-stage design over the single-stage because the device capacity is increased without influencing the time required for adsorption. The optimization was performed considering adsorption conditions in an arid environment (35% RH and 25° C.), where AWH using dewing is infeasible. Based on the optimization in FIGS. 11A-11B, L₁=L₂=6.4 mm and ε=0.7 were selected.

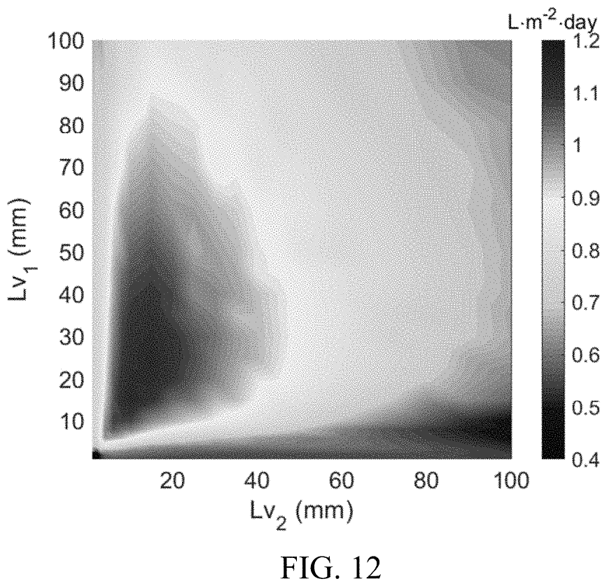

To guide the initial device design, we determined the sensitivity of water harvested to the air gap size of each stage (FIG. 12) and selected a value of Lᵥ₁=Lᵥ₂=20 mm, for which the maximum water productivity was ˜1.2 L/m²/day for the prototype at 35% RH and 25° C. This analysis was performed with Uₜ=4.5 W/m²/K, representing a lower, but achievable [37], bound on heat loss (discussed below).

The model predicted both LMD and thermal efficiency (which is proportional to LMD when calculated over the same desorption period) of a dual-stage device in comparison to a single-stage device. While the LMD is the key metric for our prototype, for completeness, the thermal efficiency was also calculated. For other applications of the dual-stage concept such as in cyclic systems, it is important to consider efficiency improvements. For the single-stage device, the same modeling approach described below was used but considered just one adsorbent layer and one air gap. The thermal efficiency was calculated as,

$${η}_{thermal} = \frac{{m}_{water} {h}_{f g}}{{Q}_{i n}} \qquad ( 1 )$$

where m_{water} is the mass of water harvested, h_{fg} is the latent heat of condensation, and Qᵢₙ is the solar energy received by the solar absorber from the time when the device is first exposed to sunlight to the time when water harvesting stops. For both the dual-stage and single-stage simulations, we assumed a constant solar flux=1000 W/m² (modified by a solar absorptance=95% and convection cover transmittance=92%), and ε=0.7. We used the above optimized values of L₁, L₂, Lᵥ₁, and Lᵥ₂. We assumed the layers were initially equilibrated at 35% RH and 25° C. prior to desorption to represent arid climate conditions. The convective boundary condition at the finned condenser assumed a fin area ratio Aᵣ=20 and a natural convection heat transfer coefficient h=2.5 W/m²/K. FIG. 2D shows the LMD and efficiency as a function of the maximum solar absorber temperature, T_{H}, assuming a desorption period of 4 hours. The efficiency was calculated over this entire period which includes the sensible energy required for the adsorbent layers to reach their desorption temperature. T_{H} was varied by parametrically changing Uₜ, which is the heat transfer coefficient from the solar absorber to the environment on the top side of the device. Note that Uₜ does not include the heat transfer from the back side of the adsorbent layer and through the device.

The LMD and efficiency of both devices have the same curve shape in which LMD and efficiency increase with T_{H} as more water is harvested, until reaching a plateau when complete desorption of both layers is achieved in the 4 hour period. Increasing T_{H} increases the desorption rate (Equation S5), which increases the water harvesting rate and is necessary to bring the adsorbent above its desorption temperature. It was shown that T_{H} must be sufficiently high (˜90° C.) before the dual-stage device can achieve greater LMD and efficiency than the single-stage device. This temperature value or even higher temperatures are achievable by engineering the solar absorber using spectrally selective surfaces or optically transparent aerogels [37, 38].

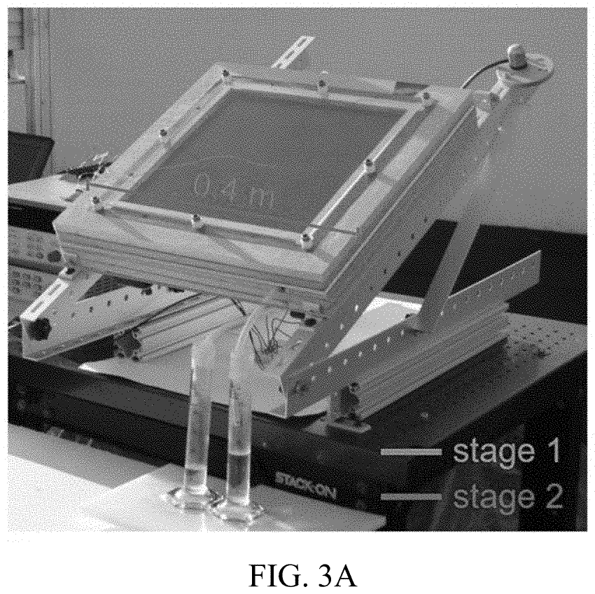

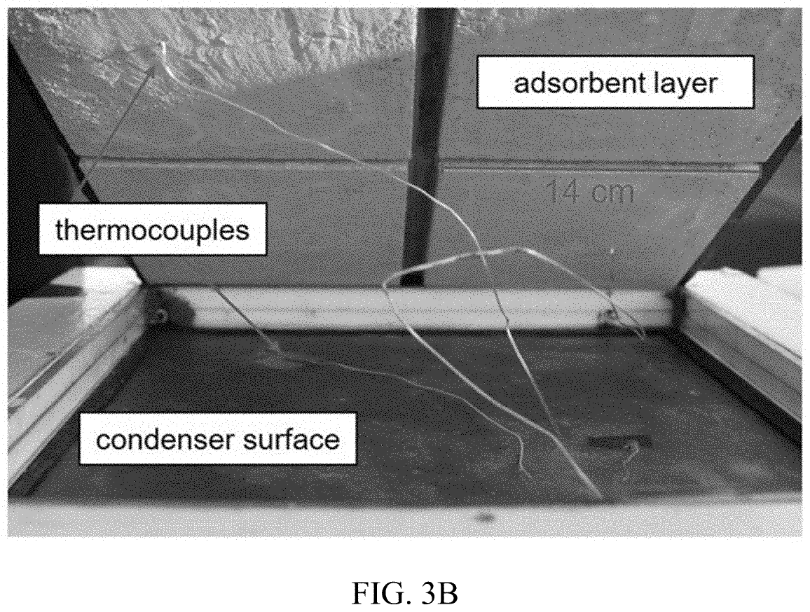

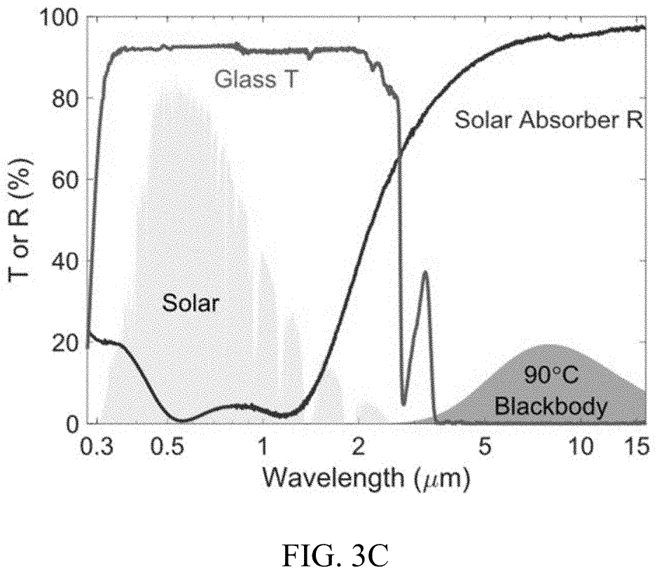

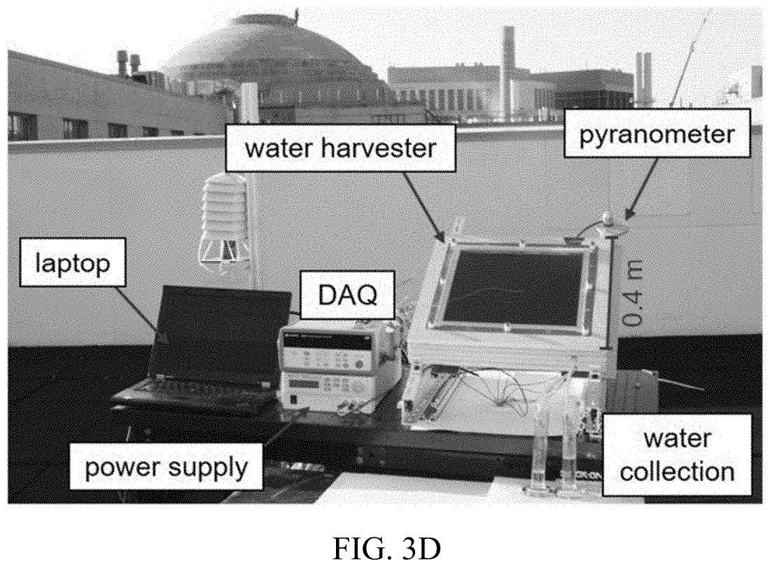

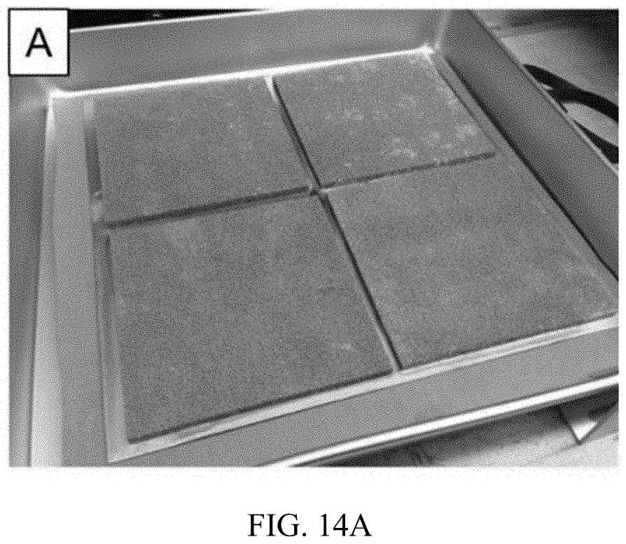

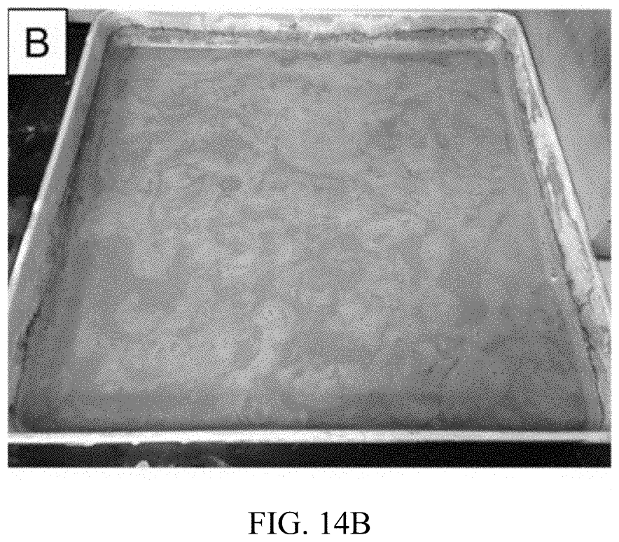

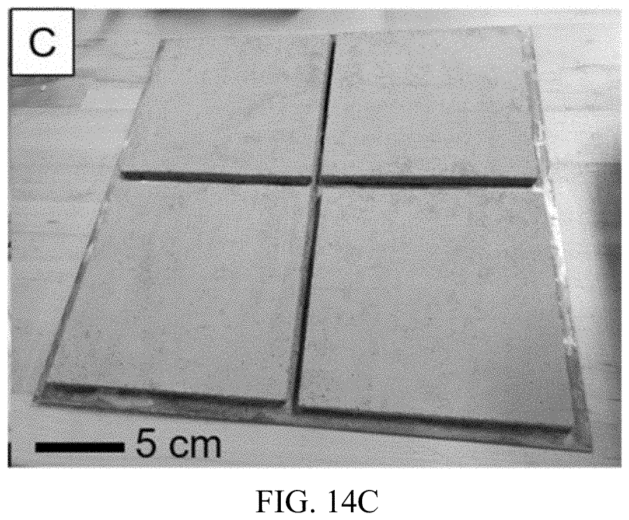

The modeling was used to guide the choice of adsorbent layer thickness (L₁=L₂=6.4 mm), air gap thickness (Lᵥ₁=Lᵥ₂=20 mm), and packing porosity (ε=0.7) for the experiments. Using AQSOA Z01, the dual-stage device has the potential to achieve greater performance provided that T_{H} is at least ˜90° C. Using these design guidelines, the prototype in FIG. 3A was fabricated with details of the composite adsorbent layer shown in FIG. 3B. The layers were fabricated by brazing nickel foam to copper sheet metal, and we infiltrated the AQSOA Z01 into the nickel foam (FIGS. 14A-14C). Note that due to challenges in fabricating the large adsorbent layers, the two layers were slightly different (Table 2), where the adsorbent mass in the top layer was 305 g (ε=0.65) and the bottom was 215 g (ε=0.75). A selective solar absorber (Alanod eta plus®) with measured absorptance=93% (weighted by the AM1.5 solar spectrum) and infrared emittance=4.2% (weighted by the blackbody spectrum at 90° C.) converted incident solar radiation to heat which was conducted to the top adsorbent layer. A glass cover (thickness ˜3 mm, transmittance=92%) was placed on top of the solar absorber to reduce convective heat loss. The measured transmittance and reflectance spectrum of the solar absorber and glass are shown in FIG. 3C.

Referring to FIG. 2A, the equilibrium adsorption isotherms of AQSOA Z01 in a N₂/vapor environment were measured at 25° C. and 65° C. The shift of the isotherm step to higher RH with temperature reduces the temperature difference between the adsorbent and condenser required for desorption. Referring to FIG. 2B, a scanning electron microscope (SEM) image of AQSOA Z01 shows a crystal size of 5-8 μm. Referring to FIG. 2C, a schematic of the device shows the dimensions of the dual-stage device which were optimized by the model. L₁ and L₂ are the thicknesses of the top and bottom adsorbent layers, respectively. L₁ and L₂ are the sizes of the top and bottom air gaps, respectively. FIG. 2D depicts model predictions for LMD and efficiency of the dual-stage and single-stage devices as a function of the maximum temperature of the solar absorber, T_{H}, and assuming four hours of exposure to sunlight. The simulation assumed overnight adsorption in arid conditions (35% RH and 25° C.). The maximum T_{H} shown for each device also corresponds to Uₜ=4.5 W/m²/K, which we consider to be a lower bound on achievable heat transfer coefficients (see below).

Referring to FIG. 3A, the prototype device consisted of two stacked stages. Condensed water drained from tubes at the bottom of each stage into separate graduated cylinders for collection. Referring to FIG. 3B, an image of the inside of the device shows an adsorbent layer, condenser surface, and the thermocouples for temperature measurements. Referring to FIG. 3C, a graph shows the measured optical transmittance (T) and reflectance (R) spectra characterized by UV-Vis-NIR spectrophotometer and FT-IR spectrophotometer of the solar absorber and the glass convection cover. The measured solar absorptance was 93% and the thermal emittance at 90° C. was 4.2%. The AM1.5 solar spectrum and the blackbody spectrum at 90° C. are plotted for reference. The blackbody spectrum intensity is not to scale with respect to the solar spectrum. Referring to FIG. 3D, the experimental setup on a rooftop is shown, which consisted of the prototype, a laptop, power supply, data acquisition equipment (DAQ), pyranometer, and two graduated cylinders for water collection.

Experimental Characterization of the Device

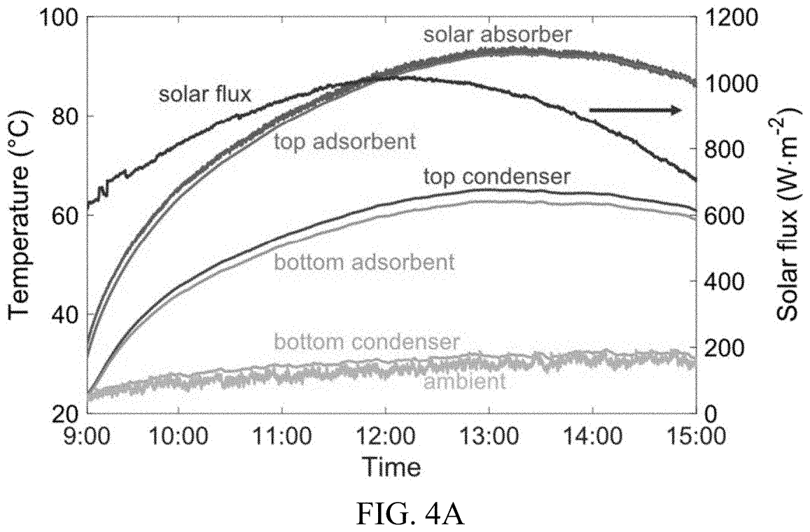

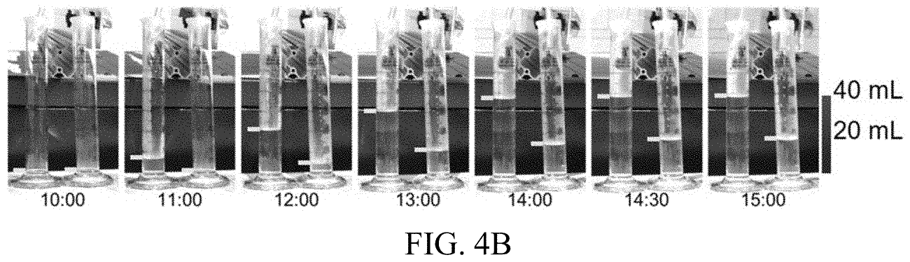

The device was tested on the rooftop of MIT (Cambridge, Mass.) for outdoor water harvesting experiments (FID. 3D). During the adsorption period, the layers were placed outside overnight under a tarp which protected them from the environment but allowed fresh air to flow to the adsorbent. Data from a weather station adjacent to the experiment were used to determine the overnight relative humidity and temperature. Although the outdoor humidity conditions were high (average overnight 68% RH) due to the test location, the adsorbent layer thickness was selected to allow complete overnight adsorption in 35% RH conditions (FIGS. 11A-11B). For the daytime desorption period, we placed the layers in the device. Using adjustable rails, the tilt angle of the device was set with respect to the horizontal to the zenith angle of the sun)(˜27° at solar noon (˜12:50 pm) during the experiments, which ensured the solar flux was normal to the absorber at solar noon. This angle also allowed condensed water to flow from the copper condenser sheets to the water collection tubes. An umbrella was used to cover the device to minimize solar heating during assembly in the morning and before the beginning of data collection. Throughout the experiment, the temperature of the adsorbent layer was measured by imbedding two thermocouples (K-Type) in each layer, which were held in place by heat sink compound (FIG. 3B). Two thermocouples were attached to each condenser surface, and a single thermocouple to the solar absorber surface. The ambient temperature (shielded from the sun) was measured and a pyranometer (LP-02, Hukseflux) was used, mounted at the same angle as the solar absorber, to measure the incident solar flux. Water harvested by each stage drained through a plastic tube and was collected in a graduated cylinder which was covered to prevent evaporation throughout the experiment. The signals from the thermocouples and pyranometer were measured by data acquisition equipment (34972A, Agilent) connected to a laptop. While modeling suggested a natural convection heat transfer coefficient h=2.5 W/m²/K was needed to sufficiently reject the heat from the finned condenser (which had Aᵣ˜20), this could not be reliably achieved during the experiment due to the stagnation of air under the unfavorable downward orientation of the fins. Therefore, a DC power supply was used to provide power to fans under the finned condenser (2.4 W total). The adsorbent layers were placed outside in average overnight temperature and RH conditions of 20° C. and 68% RH, respectively. The mass of the layer was recorded immediately before assembling the device. The temperature measurements of the adsorbent layers, condensers, solar absorber, and ambient as well as the solar flux measured by the pyranometer throughout the experiment are shown in FIG. 4A. The two thermocouple measurements were averaged for each layer and each condenser surface.

The desorption experiment started at 9:00 ET when the device was exposed to sunlight. The temperature of the solar absorber, absorbent layers, and condensers increased after solar exposure. Initially (9:00-10:00), the temperatures showed a linear increase with respect to time. Then, as desorption started after 10:00, the rate of temperature increase began to decrease. As a result, the solar absorber temperature stabilized above 90° C. from 12:15 to 14:30 with a maximum T_{H}=94° C. occurring at 13:15. However, peak solar flux (˜1000 W/m²) conditions occurred between 11:30 and 12:50. The lag between absorber temperature and solar flux was due to the specific heat capacity of the layers/device and the latent heat of desorption. In general, the temperature differences between the solar absorber and the top absorbent layer (0.68° C.) as well as between the top condenser and the bottom absorbent layer (1.7° C.) were small, indicating good thermal contacts. The temperature difference between the solar absorber and the top adsorbent layer was slightly larger while desorption was occurring (due to the latent heat of desorption in the layer) than at the start and end of the experiment when desorption ceased. Likewise, there was also a larger temperature difference between the top condenser and bottom adsorbent while the bottom layer was desorbing. Besides a high solar absorber temperature, it is also important to maintain a low finned condenser temperature to establish a large temperature gradient throughout the device. In our device, the bottom condenser sufficiently rejected heat from the device, as the temperature remained less than 4° C. above the average ambient temperature. The maximum bottom adsorbent temperature was 63° C. and maximum ambient temperature was 33° C. during the experiment.

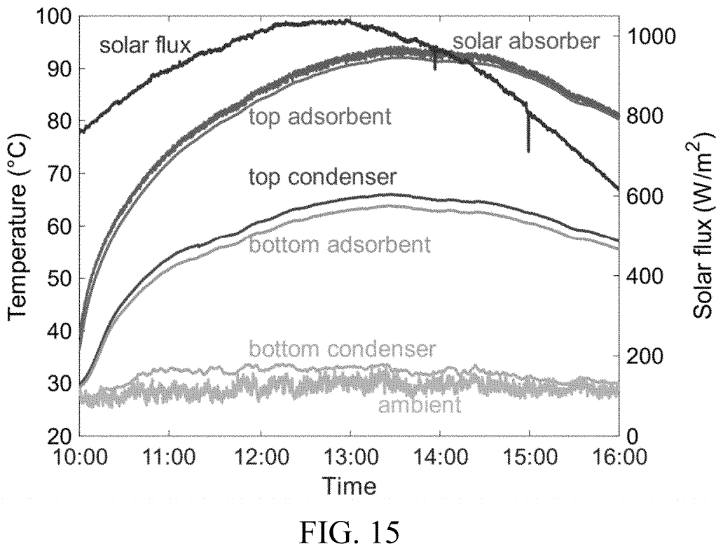

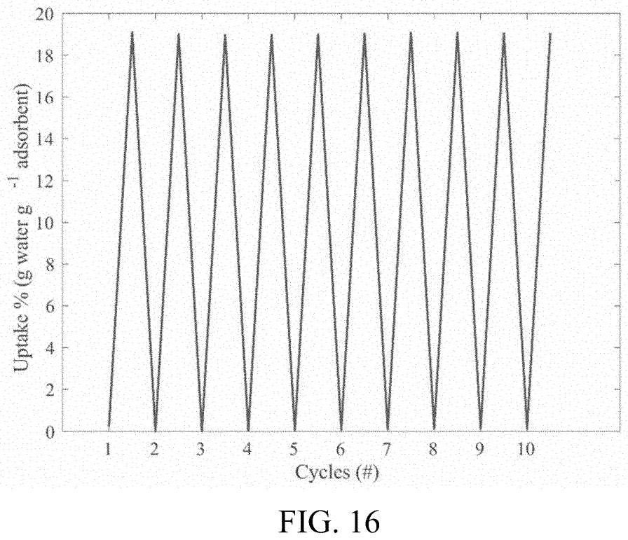

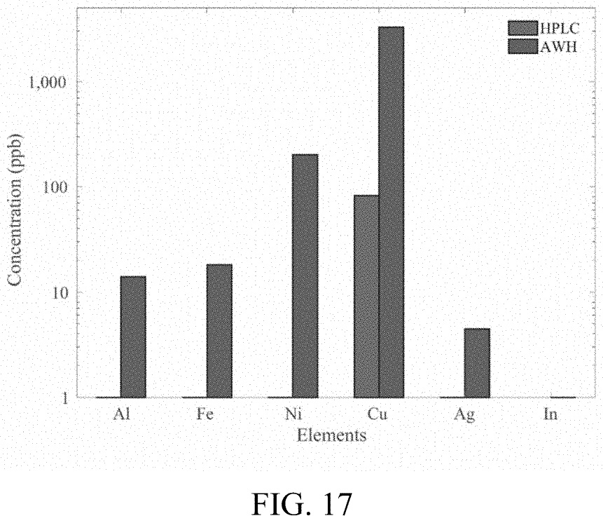

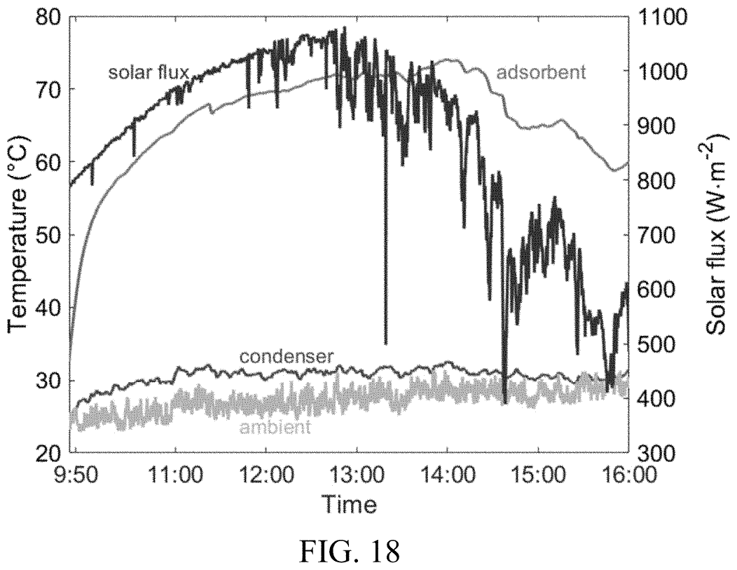

During the experiment, water collection was observed in the beakers between ˜10:15 and ˜14:30. Water collected from both stages throughout the experiment is shown in FIG. 4B. In total, ˜60 mL of water was collected with ˜40 mL from the top stage and ˜20 mL from the bottom stage. Considering the 0.078 m² area of the solar absorber, this translates to ˜0.77 L/m²/day. This water collection is a significant improvement over prior work in which ˜0.34 L/m²/day and ˜0.75 mL of water was collected [11]. Using Equation 5, the efficiency of water collection was calculated, where Qᵢₙ now included the solar energy received by the device as well as the power consumption of the fan. The electrical power consumption of the fan (2.4 W electric) was converted back to thermal energy assuming it was powered by a solar panel at 20% conversion efficiency [39]. We then added this to the time-varying solar flux measured for the 5.5 hours between the start of the experiment (9:02) and the end of water collection (14:30). The calculated thermal efficiency was ˜9%, which included the fan power (i.e., ˜10.6% without the inclusion of fan power). Results of another experiment which was performed approximately one month earlier indicated good repeatability between experiments without degradation of uptake by the adsorbent layer (FIG. 15). Additionally, cyclic adsorption stability studies on AQSOA Z01 showed no significant degradation in uptake after many cycles (FIG. 16). Water quality measurements (FIG. 17) indicated that the primary contaminants in the harvested water were due to metals present in the device components (Cu from the condenser surfaces and Ni from the foam), not the adsorbent itself, indicating that these issues can be resolved by selecting different component materials. To compare to the dual-stage device, experiments were also completed using a single-stage configuration which was constructed by using the top adsorbent layer (with integrated solar absorber) and the finned condenser. In this single-stage experiment, ˜51 mL (˜0.65 L/m²/day) and T_{H}=78° C. (FIG. 18) was harvested. Considering the time-varying solar flux measured over the 4 hours between the start of the experiment (9:50) and the end of water collection (13:50) as well as the fan power, the thermal efficiency was ˜9.5% (without including the fan power, it was ˜11.6%). In the following section, reasons why these efficiencies were approximately the same and show modeling results that allow comparison between the two devices under the same conditions are discussed.

The experimental results are summarized below. The mass of the adsorbent layers was measured immediately before and after the experiment (Table 3), and the difference in mass was the desorbed water (Table 4). The desorbed water was compared to the condensed water collected in the cylinders and from residual droplets in the device to determine the condensation recovery. The condensation recovery for both experiments was high (98.7-99.2%), indicating successful condensation of the desorbed water and minimal vapor leakage. The percentage of water condensed and recovered from the adsorbent layers was also calculated. Although the dual-stage device had a greater LMD, the water recovery of the single-stage was higher than the dual-stage (88% and 54.7%, respectively) due to more complete desorption by the single-stage device.

Referring to FIG. 4A, experiment results, including real-time temperatures of the device components and solar flux evolution, are shown. The experiment ran from 9:00 to 15:00. The solar flux reached its maximum at 12:00 while peak temperature of the device occurred at 13:00. The time delay between the two peaks is due to the heat capacity of the device and the latent heat of desorption. Referring to FIG. 4B, time-lapsed photos recording the amount of water collected in the graduate cylinders are shown. Water harvesting was observed between 10:15 and 14:30 with a total ˜60 mL. ˜40 mL was collected from the top stage and ˜20 mL was collected from the bottom stage (including residuals left on the interior surfaces of the device which were collected using a cloth). Markers to the left of the water level on each cylinder show the relative height of the water.

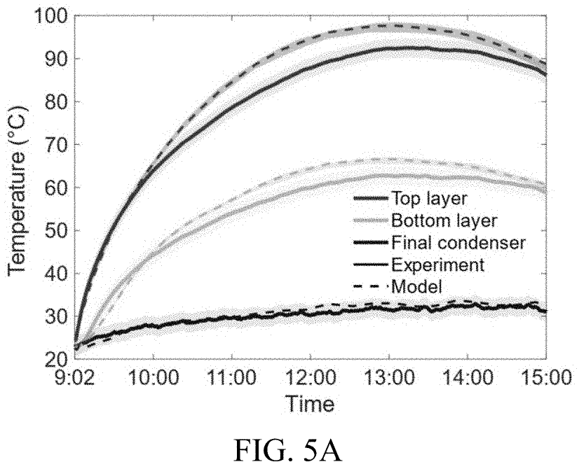

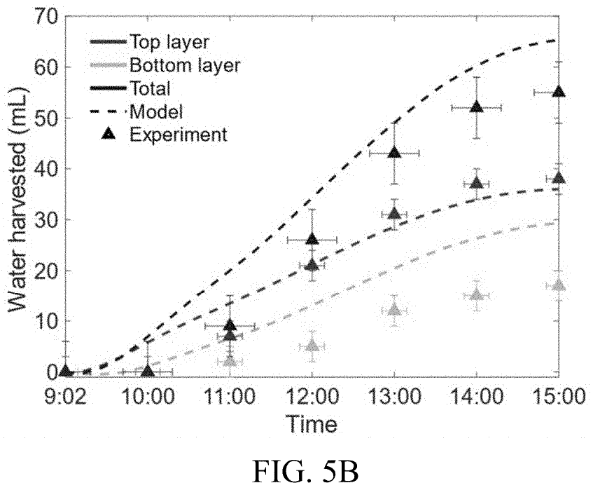

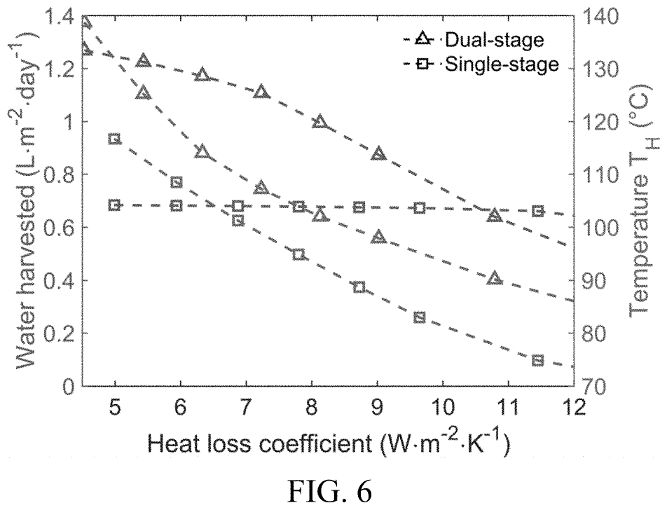

Using the model, including the time-varying solar flux during the experiment as an input, we compared the measured temperature of each adsorbent layer and the bottom condenser to those predicted by the model (FIG. 5A) for the dual-stage device. Based on the calculations presented below, an average top heat transfer coefficient of Uₜ˜9 W/m²/K (Uₜ varied with temperature throughout the experiment) was used. Good agreement between our experiments and model were shown, as the temperatures differed by less than 6° C. The discrepancy was attributed to more heat loss between the stages of the device by convection in the air gaps or conduction through the side walls. FIG. 5B shows the water harvested during the experiment compared to the model predictions. The water harvested at different times during the experiment was estimated from time-lapse images. The rate of water harvesting (rate at which water condensed at each stage) could not be accurately measured in real time because water droplets did not immediately drain from the device due to surface tension forces on the copper condensing surfaces. Nevertheless, the time lapse photos provided an estimate for the rate of water harvesting in FIG. 5B. The error bars estimate the uncertainty associated with the time lapse images. The model predicted a total of 66 mL of water harvested, or 0.85 L/m²/day. The model over-predicted the water harvested by the top layer due to the over-predicted temperature difference between the top adsorbent layer and its condenser and under-predicted the water harvested by the bottom layer due to its under-predicted temperature difference.

Although the dual-stage device produced 18% more water than the single stage, two factors contributed to the comparable efficiencies. The T_{H} of the dual and single-stage experiments were 94° C. and 78° C., respectively. According to the general modeling in FIG. 2D, the dual-stage device was expected slightly greater efficiency and LMD for a given desorption period. However, the desorption time for the single-stage device was observed to be 4 hours and that for the dual-stage device was 5.5 hours (where these times included device sensible heating). When factoring in these time differences to the efficiency, the efficiencies became comparable. Additionally, the heat capacity of the dual-stage device was larger than the single-stage because a greater mass of materials and surrounding components were required, and sensible heating was included in the efficiency calculation. While the general model in FIG. 2D did account for the difference in heat capacity between the layers, it did not include the device-specific heat capacity which includes the surrounding components (which was determined by obtaining a fit to the slope of the adsorbent layer temperature).

Furthermore, it can be difficult to draw a direct comparison between the two device experiments for several reasons. First, the experiments were performed on different days under different solar flux conditions and overnight adsorption occurred at different RH and temperature. The total mass of adsorbent in the dual-stage experiment was consistent with the dual-stage model in FIG. 2D which assumed £=0.7 for both layers. However, as previously noted, a top layer with more mass was used in the single-stage experiment which artificially increased its performance for the purpose of direct comparison.

To better compare the two devices, both were modeled under the conditions observed in the dual-stage experiment. To draw comparisons to the experimental performance of the prototype, the modeling was performed using the device specific heat capacity, as well as the overnight adsorption RH, temperature, and time-varying solar flux measured in the dual-stage experiment. The single-stage device used a single optimized adsorbent layer (FIGS. 11A-11B) with the same characteristics as an individual layer in the dual-stage device (ε=0.7 and L=6.4 mm). The devices were modeled with the same convective boundary condition at the finned condenser (Aᵣ=20 and h=2.5 W/m²/K). A tradeoff exists between the maximum LMD and efficiency due to the greater time required to achieve complete desorption than the time at which peak efficiency is reached. This result is because the water harvesting rate depends on the concentration in the adsorbent (Equation S5), and accordingly, the water harvested per energy input is much lower towards the end of the desorption period. Furthermore, when comparing the two devices, the dual-stage has a higher heat capacity and higher required T_{H} than the single-stage, which leads to a greater sensible heating requirement. As noted earlier though, it is believed that LMD is the more important metric for the device discussed in this work because our solar-thermal driven device operates on a single daily cycle.

As a result, the potential to increase the LMD (FIG. 6) was investigated by design modifications to reduce the average Uₜ (heat loss from the solar absorber to the environment) and consequently increase T_{H}. Comparing the device-specific model (FIG. 6) to the general model in FIG. 2D, it was seen that the two show consistent behavior, noting that FIGS. 2A-2D was modeled at 35% RH (compared to 68% RH in the experiment) so the LMD was slightly lower. For the calculated Uₜ for the device (˜9 W/m²/K), the LMD predicted by the model agreed well with the experiment, noting the agreement was even better at the experimental T_{H}=94° C. which suggests small differences between the model and experiment are actually due to more heat loss from one stage to the next (radiative, convective, or conduction through the side walls) rather than from the solar absorber to the environment. By reducing Uₜ by 50% from the experiment, the maximum water harvesting potential of the device at this humidity (˜1.3 L/m²/day) was approached and almost twice the LMD of the single-stage device can be achieved. For the same Uₜ, the dual-stage device can reach a higher T_{H} because the bottom adsorbent layer acts as a more insulating boundary condition than the colder finned condenser. Thus, there is greater potential for the dual-stage device to increase LMD by increasing T_{H}, and as the temperature difference between the stages increases. Other heat sources can be used to achieve higher T_{H} such as combustion, gasification, or waste heat [3, 4].

Besides design modifications to reduce Uₜ and increase T_{H}, reduction in the heat capacity can reduce the sensible energy required for the device to reach its desorption temperature. The dual-stage device heat capacity was greater than the single-stage which allowed the single-stage to reach steady-state conditions more-quickly (as evident by the slope of the adsorbent temperature in FIG. 4A and FIG. 18). This effect negatively impacted the performance of the dual-stage device, but can be modified by different materials selection. For example, thinner copper condenser surfaces and aluminum foam (which is ˜⅓ the density of nickel) can be used.

The dual-stage system was demonstrated using a commercially available material which shows progress towards the scalability of solar-driven AWH devices. Greater LMD can be achieved using higher-performance materials which have a greater uptake while maintaining low energy requirements for regeneration and fast adsorption kinetics. Future studies should examine the performance of different materials in the dual-stage configuration. For the evaluation of materials for this application, the intracrystalline kinetics are needed to determine any rate-dependent metric because adsorption/desorption rate and optimal layer thickness and packing porosity are all dependent on the kinetics. Two different adsorbent materials can be used with optimized properties for the temperature requirements of each stage as is typical in cascaded adsorption systems. While the experiments were performed at MIT (Cambridge, Mass.) where the humidity was high (we achieved similar performance from our two dual-stage experiments in which adsorption occurred at 57% RH and 68% RH), the isotherm characteristics of AQSOA Z01 indicate that it can perform similarly in lower humidity environments. Both the modeling in FIG. 2D as well as the optimization of the adsorbent layer (FIG. 11A-11B), in which the adsorption kinetics were considered, were performed at 35% RH. Comparing FIG. 2D to the modeling at high humidity in the experiments (FIG. 6) indicates that similar results can be achievable with this material in climates with low RH.

There are various tradeoffs between performance, cost, and practicality to consider in the design of AWH systems. Different metrics (LIVID, L/kg/day, thermal efficiency, $/L) become relevant based on cost considerations, the type (passive solar-thermal vs cyclic), and the application of the device. Because of the focus on productivity based on LIVID and scalability based on using a commercially available material, L/kg/day metric which is relevant to consider for more expensive materials or for light-weight, portable, cyclic devices was not prioritized. Consequently, the L/kg/day harvested by the dual-stage experiment was lower than the single stage (Table 4) because the water recovery ratio was lower. However, the strategies discussed to increase the LMD herein would also result in an increase in L/kg/day. Overall, a thorough techno-economic analysis is needed to understand the value of different materials, device configurations, and the importance of different metrics [40].

For the devices examined herein, efficiency varies with the period the device is exposed to sunlight and maximizing efficiency does not result in the maximum LMD. These two metrics are relevant for different classes of systems with differing applications. In the context of passive solar-thermal AWH systems that operate on a single daily cycle like those discussed in this work, the specific productivity metric (LIVID) is more appropriate than the efficiency metric due to its influence on land area required, the size and cost of the solar absorber, and finned condenser components. Greater LMD can reduce cost by reducing the components required for solar absorption and reduces energy required for condensation because recycling of the latent heat contributes to a reduction in the specific cooling power required at the condenser. Maximizing efficiency in these systems would only reduce the daily quantity of water harvested. However, for devices incorporating heat and mass exchangers and other active systems for cycling the adsorbent multiple times per day, the efficiency metric becomes more relevant and a dual-stage configuration can be used to improve the thermal efficiency. This configuration could be implemented in a cyclic system to reduce the electrical power consumption of the condenser.

Referring to FIG. 5A, experimental measurements and model predictions of the temperatures of the top layer, bottom layer, and the finned condenser of the device showed good agreement within 6° C. are shown. Referring to FIG. 5B, a comparison between the amount of water harvested from both stages measured in the experiment and predicted by the model is depicted. The amount of water harvested in the experiment was estimated through a series of time-lapsed photos of the water collection cylinders.

Referring to FIG. 6, a model comparison of the single-stage and dual-stage devices is shown. Model prediction for the LMD of the dual-stage device and the maximum solar absorber temperature, T_{H}, as the average top heat transfer coefficient Uₜ is varied. The modeling was done at the conditions seen during the experiment including overnight adsorption at average conditions of 68% RH and 20° C. and the time-varying solar flux measured during the experiment. To compare the two, we modeled the single-stage device at identical conditions. The LMD measured in our dual-stage experiment was ˜0.77 L/m²/day and that predicted by the model was 0.85 L/m²/day.

In conclusion, a dual-stage configuration for solar-thermal adsorption-based AWH was developed with optimized heat and mass transport to increase the daily water harvesting productivity (LMD). In outdoor experiments, a dual-stage prototype was demonstrated that harvested ˜60 mL of water (˜0.77 L/m²/day), an 18% increase over the single-stage device. A heat and mass transport model of the dual-stage device was developed to optimize the design, including the adsorbent layer thickness and air gap thickness. A solar absorber temperature of ˜90° C. was found to be the threshold temperature above which the dual-stage device can exhibit greater performance, and showed that a reduction in heat loss of 50% from the prototype can allow the dual-stage to achieve approximately twice the LMD of the single-stage device. The device, which incorporates a commercially available adsorbent, demonstrates progress towards scaling of solar-driven AWH devices. However, other adsorbent materials with fast kinetics, higher uptake than AQSOA Z01, and lower energy requirements for regeneration can be used in this configuration to achieve greater LMD. Iterations to select device components with lower heat capacity or reduce heat loss from the solar absorber can improve the performance of this configuration for even greater LMD over single-stage devices. The latent heat recovery strategy utilized by the dual-stage system can be applied to cyclic devices to increase their thermal efficiency.

Materials and Methods

Fabrication of the Adsorbent Layers

The adsorbent layer fabrication steps are detailed below and were fabricated by infiltrating AQSOA Z01 into the metallic binder. To construct the metallic binder, nickel foam (6.4 mm thick and 28 cm×28 cm) was brazed to one side of copper sheet metal (0.8 mm thick and 30.5 cm×30.5 cm) to form binder sheets. The binder sheets were made hydrophilic by rinsing in distilled water, then acetone, sonicating in distilled water, dipping the binder in 2M HCl, and then rinsing with distilled water. The AQSOA Z01 was prepared by mixing with distilled water and sonicating until the particles were suspended and the mixture was homogenous. The AQSOA Z01/water mixture was placed in a shallow pan and the binder sheet was placed in the mixture, after which the water could evaporate and the AQSOA Z01 was left imbedded in the foam.

The packing porosity was measured by first determining the bulk density of the layer, Player, or the mass of adsorbent per layer volume. To measure the mass, the total mass of the dry adsorbent and adsorbed water at equilibrium at a measured RH and temperature was recorded. Using the adsorption isotherm, the weight percent uptake of water was determined to find the mass of dry adsorbent in the layer. Table 2 shows the individual adsorbent layer components and masses. The crystal density of AQSOA Z01 is ρ_{c}=1.75 g/cm³, so the packing porosity can be calculated as [41],

$$ɛ = 1 - \frac{{ρ}_{layer}}{{ρ}_{c}} \qquad ( 2 )$$

The mass of Z01 in layer 1 and layer 2 were 305 g and 215 g, and the packing porosity were measured to be 0.65 and 0.75, respectively.

Fabrication of the Device

The device consisted of two stages which were each composed of the adsorbent layer, air gap, and a copper condensing surface. Each adsorbent layer had an area of 0.078 m². Nickel foam, which was used as the binder for the adsorbent, had a thermal conductivity that was high enough to maintain uniform temperature in the thickness dimension (S1). The side walls of each stage were composed of 6.4 mm thick acrylic (k=0.2 W/m/K), which allowed for high thermal resistance while maintain structural rigidity of the device. Acrylic was selected for its low thermal conductivity and ease of cutting. Side walls with high thermal resistance are important to minimize heat loss via conduction through the walls from one stage to the next to maintain the required temperature difference between the stages. A 3.2 mm thick rubber gasket was placed at the top and bottom of each acrylic side wall to minimize vapor leakage from the device and increase the overall thermal resistance of the side wall. The entire device was insulated with 5 cm thick polyisocyanurate insulation (k=0.023 W/m/K).

For the solar absorbing surface, selective surface Bluetec-eta plus was used which we adhered to the copper back-side of the top layer using thermal grease (Arctic-MX-4, k=8.5 W/m/K). A 1.3 cm air gap above the solar absorber provided the thermal insulation properties of air without significant natural convection, while a 3.2 mm borosilicate glass convection cover protected the solar absorber from heat loss by external convection. The copper backside of the bottom layer acted as the condenser surface for the top stage. The condenser for the bottom stage consisted of a copper sheet with aluminum heat sinks bonded to the back (area ratio ˜20). Because forced convection from the wind was not reliable, four 0.6 W CPU fans were mounted to an aluminum plate below the heat sinks and blew upwards at the heat sinks with a velocity of ˜1.5 m/s. This is the approximate wind speed required to keep the fins (in the downward orientation in the prototype) within 5° C. of the ambient at the peak heat flux at the condenser expected during the experiment.

During the adsorption phase, the device had to be disassembled to remove the adsorbent layers and place them in the open. Therefore, ease of disassembly was considered in the construction. The device was clamped together between two plates and eight bolts which ran through the insulation on the exterior of the side walls. When the bolts were tightened, the plates compressed the gaskets between the copper plate of each layer and the acrylic wall. To disassemble the device, these bolts were removed so the adsorbent layers could be removed. The bottom plate (aluminum) was mounted on two rails which could be adjusted to the zenith angle of the sun. A rubber gasket and piece of acrylic was placed below the top plate (acrylic) to provide some insulation from the solar absorber. Additional insulation was also placed over the top plate to suppress heat loss. For water collection and temperature measurements, each acrylic side wall contained two holes. One hole interfaced with a plastic tube which allowed condensed water to flow out. The other hole allowed multiple thermocouples to pass into the device for temperature measurements of the adsorbent layers and the condenser surfaces. The area around the thermocouples was sealed to mitigate vapor leakage. A hydrophobic spray (Rust-Oleum® NeverWet) was used on each copper condensing surface to aid in droplet shedding and water collection.

Adsorption isotherm, kinetics, adsorption enthalpy, and thermal conductivity of the composite adsorbent layer

Due to limitations of the TA Q5000 device, which was used for the N₂/vapor isotherms at atmospheric pressure (FIG. 2A), higher temperature measurements were challenging. Isotherms at various temperatures up to 90° C. were measured in a pure vapor environment at vacuum pressures (FIG. 7). While FIG. 7 was used to inform predictions about the device performance at high temperatures, the N₂/vapor isotherms (FIG. 2A) were used in the kinetic and enthalpy calculations described in the remainder of this section.

Referring to FIG. 7, an adsorption isotherm of AQSOA Z01 measured in a pure vapor environment using a sorption analyzer (DVS Vacuum, Surface Measurement Systems Ltd.) is shown in the graph.

The intracrystalline diffusion coefficient, D_{μ}, and adsorption enthalpy, h_{ad}, are inputs to the model which dictate the heat transfer and kinetics of adsorption and were calculated from adsorption isotherm measurements. To calculate the intracrystalline diffusion coefficient (vapor diffusion from the exterior to interior of a micron-scale adsorbent crystal), Fick's law was used with the assumption of a spherical crystal,

$$\frac{{m}_{t}}{{m}_{e q}} = 1 - \frac{6}{{π}^{2}} {\sum }_{n = 1}^{∞} \frac{1}{{n}^{2}} exp ( \frac{- {n}^{2} {π}^{2} {D}_{μ} t}{{r}_{c}^{2}} ) \qquad ( S 1 )$$

where mₜ/m_{eq} is the fractional uptake as a function of time, t, and r_{c} is the crystal radius. D_{μ} was determined by fitting Equation S1 to the time-dependent adsorption isotherm (FIG. 8A) for a step in the relative humidity (RH) which was measured using a sorption analyzer (Q5000, TA) in a N₂/vapor environment. Therefore, the calculated value of D_{μ} is a representation of kinetics in an air/vapor environment. At 25° C. and 20-25% RH the characteristic value of D_{μ}=5.7×10⁻¹⁶ m²/s. For this calculation, an average r_{c}=3 μm was assumed. A comparison between the air/vapor diffusion coefficients calculated for AQSOA Z01 as compared to MOF-801, which was characterized in prior work [16], is shown in FIG. 8B. In the calculation of D_{μ} for MOF-801, the crystal was also assumed to be spherical and r_{c}=0.3 μm [16].

The term h_{ad} was estimated using the Clausius-Clapeyron equation,

$${h}_{ad} = R \frac{\partial ( ln P )}{\partial ( - \frac{1}{T} )} {\vert}_{uptake} \qquad ( S 2 )$$

where P is pressure, T is temperature, and R is the gas constant. Equation S2 can be applied to AQSOA zeolites because they do not exhibit significant hysteresis in adsorption/desorption cycles [33]. The linear fit is shown in FIG. 9A, and the calculated value of adsorption enthalpy is shown in FIG. 9B. The thermal conductivity of the composite adsorbent layer, k, was calculated as,

k=γkₐ+(1−γ)kₛ (S3)

where γ is the foam porosity, kₐ is the thermal conductivity of the powdered adsorbent, and kₛ is the thermal conductivity of the metal foam. Equation S3 is the parallel model for thermal conductivity in foams, which gives an upper bound on the thermal conductivity but provides a good approximation at high foam porosity [42, 43]. In the prototype, nickel foam (kₛ˜91 W/m/K) with γ=0.96 was used. Approximating the thermal conductivity of the zeolite as kₐ˜0.2 W/m/K, then k˜4 W/m/K. This result indicates that the composite layer is approximately isothermal in the thickness direction for all thicknesses considered in the modeling (2 mm-10 mm) based on the Biot number, Bi=hL/k, where h is the external heat transfer coefficient and L is the layer thickness. For example, for an external heat transfer coefficient h=20 W/m²/K (upper bound on heat loss from the layer during desorption), Bi=0.05 for L=10 mm indicating even the thickest layer considered by our study is approximately isothermal.

Referring to FIG. 8A, a fitting of Fick's law in a spherical crystal to the adsorption isotherm to calculate the intracrystalline diffusion coefficient is shown. Referring to FIG. 8B, calculated air/vapor diffusion coefficients for Z01 are compared with previously characterized MOF-801.

Referring to FIG. 9A, a linear fit of the adsorption isotherm to the Clausius-Clapeyron equation is shown. Referring to FIG. 9B, the calculated adsorption enthalpy from the adsorption isotherm is shown.

Modeling Framework

The model is described by four governing equations (Equation S4-S7) which were applied to the adsorbent layers and the air gaps and were solved using COMSOL Multiphysics (FIG. 10). The dependent variables of the model are temperature, T, adsorbed concentration, Cₐ, and concentration in the voids between the crystals that is not yet adsorbed, C. Equation S4 describes the vapor diffusion between the adsorbent crystals and was applied to both adsorbent layers (domain 1 and 3),

$$\frac{\partial C}{\partial t} = ∇ \cdot {D}_{v} ∇ C - \frac{( 1 - ɛ )}{ɛ} \frac{\partial {C}_{a}}{\partial t} \qquad ( S 4 )$$

where t is time, Dᵥ is the intercrystalline vapor diffusivity (diffusion of vapor between the adsorbent crystals), and E is the packing porosity of powdered adsorbent in the metal binder. Dᵥ (˜10⁻⁵ m²/s) was calculated using the method discussed in prior work by Kim et al. [16]. The rate of adsorption is described by the linear driving force model for adsorption,

$$\frac{\partial {C}_{a}}{\partial t} = \frac{15}{{r}_{c}^{2}} {D}_{μ} ( {C}_{e q} - {C}_{a} ) \qquad ( S 5 )$$

where r_{c} (5-8 μm) is the crystal size, D_{μ} (5.7×10⁻¹⁶ m²/s) is the intracrystalline diffusivity (FIGS. 8A-8B), and C_{eq} is the equilibrium concentration of vapor given by the adsorption isotherm (FIGS. 9A-9B), and was also applied to both adsorbent layers (domain 1 and 3).

The governing heat transfer equation was applied to the adsorbent layers and the air gaps (domain 1-4),

$$ρ {c}_{p} \frac{\partial T}{\partial t} = ∇ \cdot k ∇ T + {h}_{a d} ( 1 - ɛ ) \frac{\partial {C}_{a}}{\partial t} . \qquad ( S 6 )$$

where ρ, cₚ, k, and h_{ad} are the locally averaged density, heat capacity, thermal conductivity, and enthalpy of adsorption, respectively. The calculation to determine D_{μ}, h_{ad}, and the composite k is discussed above. The heat source/sink term on the right-hand side of Equation S6 couples h_{ad} with the adsorption/desorption rate ∂cₐ/∂t from Equation S5. The density and heat capacity account for the binding material, dry adsorbent, adsorbed water phase, and bulk vapor.

Vapor diffusion in the air gaps (domain 2 and 4) between the adsorbent layers is described by Fick's law,

$$\frac{\partial C}{\partial t} = {D}_{vap} {∇}^{2} C \qquad ( S 7 )$$

where Dᵥₐₚ is the diffusivity of vapor in air. The model assumed the device was perfectly horizontal, so convective heat and mass transport were neglected in the air gaps. A saturated vapor concentration boundary condition was applied to each condenser surface because the air gaps quickly reached local 100% RH conditions.

The model was used to predict the performance improvements which can be obtained using the dual-stage configuration and to optimize L₁, L₂, Lᵥ₁, and Lᵥ₂. Temperature and concentration boundary conditions were applied (FIG. 10) to solve Equations S4-S7. An incident solar flux (Q″ₛₒₗₐᵣ) is absorbed by the solar absorber (absorptance αₐ) and modified by the convection cover transmittance, τ. The heat loss from the top is Q″_{loss,top}, where Uₜ is the combined top heat transfer coefficient (calculated below), and Tₑ is the temperature of the ambient environment. The heat loss from the sides of the device is Q″_{loss,side}, where U_{side} is the combined heat transfer coefficient of the insulation and external convection. The heat loss at the bottom of device, Q″_{loss,condenser}, is determined from the heat transfer coefficient, h, and area ratio, Aᵣ, of the finned final condenser. At each condenser surface inside the device, a condensation heat flux is applied, Q″_{cond}, where J is the flux of vapor at the condenser surface, and h_{fg} is the latent heat of condensation. The flux of vapor is determined by Fick's Law,

J=−Dᵥₐₚ∇C (S8)

where Dᵥₐₚ is the diffusion coefficient of vapor in air and C is vapor concentration. There is no flux of adsorbed concentration Cₐ out of the adsorbent layers and there is no flux of vapor concentration C between stages. Radiation heat transfer in the air gaps is included and coupled to the other governing equations. All interior surfaces were assumed to be diffuse and gray, so the radiosity of each interior surface Jᵢ, irradiation Hᵢ, and net flux qᵢ are,

$$\begin{matrix}{J}_{i} = {ɛ}_{i} σ {T}^{4} + ( 1 - {ɛ}_{i} ) {H}_{i} & ( S 9 ) \\ {H}_{i} = {\sum }_{j = 1}^{4} {F}_{i j} {J}_{j} & ( S 10 ) \\ {q}_{i} = {J}_{i} - {H}_{i} & ( S 11 )\end{matrix}$$

respectively, where εᵢ is the emissivity of each surface, and Fᵢⱼ is the view factor between surfaces.

Referring to FIG. 10, a schematic shows domains and boundary conditions used in the dual-stage model.

Optimization of the Adsorbent Layer and Air Gap Size

Daily water harvesting capacity is set by the kinetics of adsorption, which are primarily influenced by layer thickness and packing porosity [36]. Using the modeling framework, heat and mass transport in the design of the adsorbent layer for a daily cycle was considered. Using Equations S4-S6 a single adsorbent layer in which adsorption occurs from one side was modeled. External boundary conditions (BC) of 35% RH and temperature of 20° C. were assumed to represent operation in an arid climate. The 35% RH BC was imposed by creating a constant concentration BC (i.e., a Dirichlet BC). Assuming water vapor is an ideal gas, temperature and RH can be related to vapor concentration for this BC,

$$R H = \frac{P}{{P}_{sat} ( T )} = \frac{C R T}{{P}_{sat} ( T )} \qquad ( S12 )$$

where P is the partial pressure of water vapor in air, T is the ambient temperature, Pₛₐₜ(T) is the saturation pressure of water vapor at T, and C is the vapor concentration.

The influence of two design parameters, layer thickness and packing porosity, was investigated on the metrics of L/m²/day (FIG. 11A) and L/kg/day (FIG. 11B). The analysis was restricted to a single daily cycle. In all packing porosity and layer thickness cases simulated, adsorption was rate limiting. Therefore, the model simulated water which can be harvested after 18 hours of adsorption (allowing for 6 hours of desorption by sunlight) to represent productivity in a single day. The external convection heat transfer coefficient was assumed to be 20 W/m²/K for all cases (external convection due to air flow over the adsorbent layers when they are placed out of the device during the overnight adsorption process).

Referring to FIG. 11A, model results showing L/m²/day are shown. Referring to FIG. 11B, L/kg/day is shown as layer thickness and packing porosity are varied. Adsorption conditions are 35% RH and 20° C.

The L/m²/day first increases with increasing porosity due to less restricted vapor transport, but then decreases due to lower overall adsorbent density at higher porosity. At low porosity, layer thickness does not have a large impact on L/m²/day because it is limited by transport. As packing porosity increases, L/kg/day reaches a maximum which is its equilibrium value given by the adsorption isotherm. At low porosity, L/kg/day is restricted by transport limitations. Additionally, as layer thickness increases, L/kg/day decreases because thicker layers saturate more slowly, especially at lower packing porosity. At higher porosity, one can see increased utilization of thicker adsorbent layers (i.e., greater L/kg/day). Maximizing the L/kg/day metric is important if the adsorbent material cost is limiting. Maximizing LMD reduces the system size and the area required for solar heating and it could increase the thermal efficiency as long as desorption time does not become significantly longer. Overall, when the adsorption conditions are at low RH (35%), a layer thickness of 6-8 mm and packing porosity of 0.6-0.7 is optimal for layers with both high LMD and high L/kg/day. Using thicker adsorbent layers produces diminishing returns on the adsorbent mass and reduces the full utilization of the adsorbent material. To balance the tradeoffs between L/kg/day and L/m²/day, we selected a layer thickness of 6 mm and porosity of 0.7 for our prototype.

Variations in air gap size (Lᵥ₁ and Lᵥ₂) affect the temperatures of the adsorbent layers and condensers, and the temperature difference between a layer and its corresponding condenser surface impact the driving force for desorption based on Equation S5. This is because for a given solar heat flux, the temperature difference between a layer and its condenser increases with Lᵥ due to the thermal resistance across the layer of air. A parametric study of the LMD was performed as a function of Lᵥ₁ and Lᵥ₂ (FIG. 12). This parametric study was performed under heat loss conditions in which Uₜ˜4.5 W/m²/K, representing a lower bound on heat loss as calculated herein. Based on the optimization in FIGS. 11A-11B, a layer thicknesses ˜6 mm (6.4 mm due to standard material sizes) and ε=0.7 was used. Adsorption was assumed to occur at 35% RH and 25° C. to represent arid conditions. The simulation used a constant solar flux Qₛₒₗₐᵣ=1000 W/m² with an allowable desorption time of 6 hours, and condenser heat rejection hAᵣ=50 W/m²/K.

LMD of the top stage first increased with increasing Lᵥ₁ before decreasing due to slower vapor transport and increased side area for heat loss. The same trend for the LMD of the bottom stage can be seen for variations in Lᵥ₂. Therefore, the results show that it is desirable to have approximately equal values of Lᵥ₁ and Lᵥ₂. A value of Lᵥ₁=Lᵥ₂=20 mm was selected, of which the maximum water productivity is ˜1.2 L/m²/day if adsorption conditions are 35% RH.

FIG. 12 shows that the amount of water harvested (LMD) varies with Lᵥ₁ and Lᵥ₂ which influence the temperature of each adsorbent layer and condenser surface and affects the driving force for desorption.

Calculation of the Combined Heat Transfer Coefficient from the Top of the Device

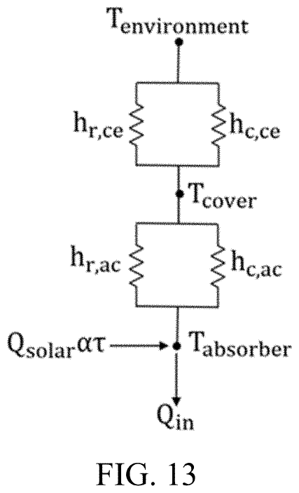

The top of the device consists of a selective solar absorber, air gap, and convection cover. The total heat loss can be modeled considering convection and radiation from the solar absorber to the convection cover as well as convection and radiation from the cover to the ambient. This heat loss network is described in FIG. 13 and the equations are defined in Table 1. Solar radiation, Qₛₒₗₐᵣ, is received at the solar absorber with solar absorptivity a after passing through the convection cover with transmissivity τ. In Table 1, Tₐ is the absorber temperature, T_{c} is the convection cover temperature, and Tₑ is the environmental temperature. εₐ is the emissivity of the absorber, ε_{c} is the emissivity of the convection cover, kₐᵢᵣ is the thermal conductivity of air, and L_{c} is the size of the air gap between the convection cover and absorber.

Referring to FIG. 13, a diagram of a thermal resistance network shows the radiative and convective heat loss modes from the solar absorber to the environment.

TABLE 1
Heat transfer coefficients for the calculation of the combined heat transfer
coefficient from the top of the device

| | | | |
|---|---|---|---|
| h_{r,ac} | Radiation between absorber and cover | ${h}_{r , ac} = \frac{σ ( {T}_{a}^{2} + {T}_{c}^{2} ) ( {T}_{a} - {T}_{c} )}{\frac{1}{{ɛ}_{a}} + \frac{1}{{ɛ}_{c}} - 1}$ | (S13) |
| h_{c,ac} | Convection between absorber and cover | ${h}_{c , ac} = \frac{( N u ) {k}_{air}}{{L}_{c}}$ | (S14) |
| h_{r,ce} | Radiation between cover | h_{r,ac} = ε_{c} σ(T_{c}² + Tₑ²) (T_{c} + Tₑ) | (S15) |
| | and environment | | |

h_{c,ce} is the convection coefficient between the cover and the environment, which varies based on wind speed. The Nu correlation to describe h_{c,ac} is given by,

$$N u = 1 + 1.4 {4 [ 1 - \frac{1708 {( sin 1.8 β )}^{1.6}}{Ra cos β} ] [ 1 - \frac{1708}{Ra cos β} ]}^{+} + {[ {( \frac{R a cos β}{5830} )}^{\frac{1}{3}} - 1 ]}^{+} \qquad ( S16 )$$

a correlation by Hollands et al. which describes a narrow horizontal cavity in which the bottom plate is heated and β is the tilt angle of the plate [44]. The characteristic length in the Nu correlation is the spacing between the solar absorber and the convection cover, L_{c}. In Equation S16, the plus sign indicates that the term should only be included if it is positive. That way Nu=1 (pure conduction) before the critical spacing and angle for natural convection to begin. The Ra number and combined top heat transfer coefficient, Uₜ, are,

$$\begin{matrix}Ra = \frac{g β ( {T}_{a} - {T}_{c} ) {L}_{c}^{3}}{{v}_{air} {α}_{air}} & ( S 17 ) \\ {U}_{t} = {( \frac{1}{{h}_{r , ac} + {h}_{c , a c}} + \frac{1}{{h}_{r , ce} + {h}_{c , c e}} )}^{- 1} & ( S 18 )\end{matrix}$$

Using a baseline value of h_{c,ce} of 20 W/m²/K, Uₜ˜4.5 W/m²/K was obtained through the solar absorber of area 0.078 m². This is a realistic lower bound on Uₜ for the device. To describe heat loss in the physical prototype, an additional resistance was introduced in parallel with the convection and radiation to the convection cover to account for heat conduction through the top cover plate (area of 394 cm²) which is in thermal contact with the edges of the solar absorber. The conduction pathway travelled through 0.8 mm thick neoprene rubber (k˜0.25 W/m/K), 6.4 mm thick acrylic (k˜0.25 W/m/K), and 5 mm thick Al (k˜240 W/m/K) before the convection heat loss to the ambient. The thermal resistance through this pathway (including convection of h_{w}=20 W/m²/K) was ˜2 K/W. Applying this in parallel with the heat transfer calculated using Equation S18, gives a calculated value of Uₜ˜9 W/m²/K for our prototype.

Fabrication of the Adsorbent Layers

Referring to FIGS. 14A-14C, images show fabrication of the Z01 layers involved (FIG. 14A) cleaning Ni foam and brazing it to copper sheet metal, (FIG. 14B) immersing the layer in a Z01/water mixture, and (FIG. 14C) evaporating the water to leave behind the Z01 infiltrated into the Ni foam.

The masses of the adsorbent layer components were measured prior to infiltrating with the zeolite (Table 2). To determine the quantity of dry adsorbent infiltrated into the Ni foam, the layer was allowed to reach equilibrium in a room temperature environment of 50% RH and 23° C. The mass of the entire layer was measured. After subtracting the mass of the components, the weight percent uptake of water was determined using the adsorption isotherm and the dry mass of adsorbent in each layer was calculated.

TABLE 2
Adsorbent layer components and masses

| Masses | Top layer (g) | Bottom layer (g) |
|---|---|---|
| Ni foam brazed to Cu sheet | 1106 | 1078 |
| Solar absorber | 87.1 | — |
| Thermal grease | 20.2 | — |
| Total components | 1214 | 1078 |
| Dry adsorbent | 305 | 215 |

Additional Dual-Stage Experiment

Referring to FIG. 15, the temperatures and solar flux were measured during the dual-stage experiment. Adsorption occurred the night before at an average overnight RH of 57% and average temperature of 26° C. In this experiment, we harvested ˜38 mL from the top stage and ˜21 mL from the bottom stage, for a total of ˜59 mL of water harvested. Considering the 0.078 m² area of the solar absorber, this translates to ˜0.76 L/m²/day. We achieved similar results in this experiment as the experiment discussed in the main text which took place a few weeks later, indicating no degradation in performance in the device or the adsorbent layers after several experiments.

Cycling Stability of AQSOA Z01

To demonstrate the robustness of AQSOA Z01 for water harvesting, cyclic adsorption and desorption experiments were performed on the material. The cyclic tests were done using a sorption analyzer (DVS vacuum, Surface Measurement Systems) in a water vapor environment. In the outdoor experiments, the peak temperature of the adsorbent was ˜90° C., while the lowest temperature was ˜25° C. Therefore, hydrothermal stability tests were performed between these two temperatures. For one cycle with extreme conditions, the chamber conditions was cycled through adsorption at 25° C. and a relative pressure of 50% to desorption at 90° C. and 5% relative pressure (FIG. 16). No significant degradation was found in uptake of the adsorbent material after 10 cycles.

Referring to FIG. 16, a graph shows the results of hydrothermal stability tests of AQSOA Z01. The result showed there was no significant degradation in uptake of the adsorbent after 10 cycles.

Water Quality Measurements

To characterize the quality of the harvested water, ion-coupled plasma mass spectroscopy (ICP-MS) with ppb (part per billion) resolution was used to measure the ion concentration of the water collected. Ions of interest included aluminum (Al), iron (Fe), nickel (Ni), copper (Cu), silver (Ag), and indium (In). The possible contamination sources are the adsorbent material (Al, Fe), metal foam (Ni), condenser surfaces (Cu), and brazing (Cu, Al, In). In FIG. 17, obvious differences in composition of harvested water and HPLC grade water were found in concentrations of Al, Fe, Cu, Ni, and Ag. The Al and Fe ions were primarily from AQSOA Z01. Ag as from the brazing between the copper plate and the adsorbent layer. The concentrations of Al, Fe, and Ag in the harvested water were greater than HPLC water, but still below the EPA secondary drinking water regulations [45]. Phosphorous (P) was not individually measured in the collected water due to challenges in ppb level mass spectroscopy measurements. However, Al and P exist at a 1:1 ratio in the adsorbent material, and the adsorbent should be their only source in the harvested water. Therefore, one can estimate P is present at concentrations no greater than ˜10 ppb. The concentrations of Ni (˜100 ppb) and Cu (˜3 ppm) were not negligible. Due to the cleaning and zeolite infiltration procedure which involved cleaning the surfaces with HCl to make them hydrophilic, the harvested water reacted heavily with the Cu and Ni. The Cu and Ni concentration can be minimized by changing the cleaning procedure of the Ni foam and Cu surfaces or selecting a different material with sufficiently high thermal conductivity. Results show In concentrations in both the collected and HPLC grade water were found to be less than 1 ppb, indicating that the In was negligible in the harvested water.

Referring to FIG. 17, water quality analysis of potential sources of contamination was tested by ICP-MS. The relatively high concentration of Ni and Cu can be reduced by modifying their cleaning procedure or selecting different materials.

Single-Stage Experiment

Referring to FIG. 18, measured temperatures and solar flux during the single-stage experiment in which ˜51 mL of water, or ˜0.65 L/m²/day was harvested are shown. Overnight adsorption conditions were an average of 58% RH and 20° C. The maximum temperature reached was T_{H}=78° C. The slope of the single-stage adsorbent temperature was steeper than the dual-stage (FIG. 15 and FIG. 4A) because the thermal mass of the single-stage device as lower. From time-lapsed photos, water collection ended at 13:50.

Summary of Experimental Results

The uptake before and after desorption was calculated by measurements of the dry adsorbent mass (Table 3) and measurements of the composite adsorbent layer mass taken before and after desorption. The uptake is defined as water adsorbed per mass of dry adsorbent. Calculated uptakes were consistent with the uptake expected at the average adsorption RH condition of each experiment.

TABLE 3
Measurements of the composite adsorbent layer
mass and uptake before and after the experiment

| | Mass before | Mass after | Uptake before | Uptake after |
|---|---|---|---|---|
| Dual-stage | desorption | desorption | desorption | desorption |
| experiment | (g) | (g) | (mL/g) | (mL/g) |
| Top layer | 1581.6 | 1541.3 | 0.21 | 0.074 |
| Bottom layer | 1338.5 | 1318.3 | 0.21 | 0.12 |
| Single-stage | 1578.1 | 1526.7 | 0.19 | 0.026 |
| experiment | | | | |

The desorbed water was calculated from the mass change of the composite adsorbent layers before and after desorption. The condensed water is the water that was collected both in the cylinders and residual droplets collected from inside the device using a cloth. The condensation recovery was calculated as the ratio of the condensed water to the desorbed water. The water recovery is the condensed water as a percentage of the initial water uptake.

TABLE 4
Experimental results

| Dual-stage | Desorbed | Condensed | Condensation | Water | | |
|---|---|---|---|---|---|---|
| experiment | water (mL) | water (mL) | recovery (%) | recovery (%) | L/m²/day | L/kg/day |
| Top layer | 40.3 | 39.8 | 98.8 | 62.1 | | 0.130 |
| Bottom layer | 20.2 | 19.9 | 98.5 | 44.1 | | 0.093 |
| Total | 60.5 | 59.7 | 98.7 | 54.7 | 0.77 | 0.115 |
| Single-stage | 51.4 | 51.0 | 99.2 | 88.0 | 0.65 | 0.167 |
| experiment | | | | | | |

It should be understood that the subject matter defined in the appended claims is not necessarily limited to the specific implementations described above. The specific implementations described above are disclosed as examples only.

### BIBLIOGRAPHY

(1) Humphrey, J. H., Brown, J., Cumming, O., Evans, B., Howard, G., Kulabako, R. N., Lamontagne, J., Pickering, A. J., and Wang, E. N. (2020). The potential for atmospheric water harvesting to accelerate household access to safe water. The Lancet Planetary Health 4, e91-e92.
(2) Tu, Y., Wang, R., Zhang, Y., and Wang, J. (2018). Progress and Expectation of Atmospheric Water Harvesting. Joule 2, 1452-1475.
(3) Wikramanayake, E. D., Ozkan, O., and Bahadur, V. (2017). Landfill gas-powered atmospheric water harvesting for oilfield operations in the United States. Energy 138, 647-658.
(4) Chaitanya, B., Bahadur, V., Thakur, A. D., and Raj, R. (2018). Biomass-gasification-based atmospheric water harvesting in India. Energy 165, 610-621.
(5) Klemm, O., Schemenauer, R. S., Lummerich, A., Cereceda, P., Marzol, V., Corell, D., van Heerden, J., Reinhard, D., Gherezghiher, T., Olivier, J., Osses, P., Sarsour, J., Frost, E., Estrela, M. J., Valiente, J. A., and Fessehaye, G. M. (2012). Fog as a fresh-water resource: overview and perspectives. Ambio 41, 221-234.
(6) Wahlgren, R. V. (2001). Atmospheric water vapour processor designs for potable water production: a review. Water Research 35, 1-22.
(7) Gido, B., Friedler, E., and Broday, D. M. (2016). Assessment of atmospheric moisture harvesting by direct cooling. Atmospheric Research 182, 156-162.
(8) Bagheri, F. (2018). Performance investigation of atmospheric water harvesting systems. Water Resources and Industry 20, 23-28.
(9) Peeters, R., Vanderschaeghe, H., Rongé, J., and Martens, J. A. (2020). Energy performance and climate dependency of technologies for fresh water production from atmospheric water vapour. Environmental Science: Water Research & Technology 6, 2016-2034.
(10) Kim, H., Rao, S. R., LaPotin, A., Lee, S., and Wang, E. N. (2020). Thermodynamic analysis and optimization of adsorption-based atmospheric water harvesting. International Journal of Heat and Mass Transfer, 120253 (In Press).
(11) Kim, H., Rao, S. R., Kapustin, E. A., Zhao, L., Yang, S., Yaghi, O. M., and Wang, E. N. (2018). Adsorption-based atmospheric water harvesting device for arid climates. Nature Communications 9, 1191-1191.
(12) Fathieh, F., Kalmutski, M. J., Kapustin, E. A., Waller, P. J., Yang, J., and Yaghi, O. M. (2018). Practical Water Production from Desert Air. Science Advances 4.
(13) Hanikel, N., Prévot, M. S., Fathieh, F., Kapustin, E. A., Lyu, H., Wang, H., Diercks, N. J., Glover, T. G., and Yaghi, O. M. (2019). Rapid Cycling and Exceptional Yield in a Metal-Organic Framework Water Harvester. ACS Central Science 5, 1699-1706.
(14) Terzis, A., Ramachandran, A., Wang, K., Asheghi, M., Goodson, K. E., and Santiago, J. G. (2020). High-Frequency Water Vapor Sorption Cycling Using Fluidization of Metal-Organic Frameworks. Cell Reports Physical Science 1, 100057.
(15) Hanikel, N., Prévot, M. S., and Yaghi, O. M. (2020). MOF water harvesters. Nature Nanotechnology 15, 348-355.
(16) Kim, H., Yang, S., Rao, S. R., Narayanan, S., Kapustin, E. A., Furukawa, H., Umans, A. S., Yaghi, O. M., and Wang, E. N. (2017). Water harvesting from air with metal-organic frameworks powered by natural sunlight. Science 356, 430-434.
(17) Kalmutzki, M. J., Diercks, C. S., and Yaghi, O. M. (2018). Metal-Organic Frameworks for Water Harvesting from Air. Advanced Materials 30, 1-26.
(18) Rieth, A. J., Yang, S., Wang, E. N., and Dinc\check{a}, M. (2017). Record Atmospheric Fresh Water Capture and Heat Transfer with a Material Operating at the Water Uptake Reversibility Limit. ACS Central Science 3, 668-672.
(19) Rieth, A. J., Wright, A. M., Skorupskii, G., Mancuso, J. L., Hendon, C. H., and Dinc\check{a}, M. (2019). Record-Setting Sorbents for Reversible Water Uptake by Systematic Anion Exchanges in Metal-Organic Frameworks. Journal of the American Chemical Society 141, 13858-13866.
(20) Teo, H. W. B., Chakraborty, A., Kitagawa, Y., and Kayal, S. (2017). Experimental study of isotherms and kinetics for adsorption of water on Aluminium Fumarate. International Journal of Heat and Mass Transfer 114, 621-627.
(21) Krajnc, A., Varlec, J Mazaj, M., Ristić, A., Logar, N. Z., and Mali, G. (2017). Superior Performance of Microporous Aluminophosphate with LTA Topology in Solar-Energy Storage and Heat Reallocation. Advanced Energy Materials 7, 1-8.
(22) Matsumoto, K., Sakikawa, N., and Miyata, T. (2018). Thermo-responsive gels that absorb moisture and ooze water. Nature Communications 9, 2315.
(23) Zhao, F., Zhou, X., Liu, Y., Shi, Y., Dai, Y., and Yu, G. (2019). Super Moisture-Absorbent Gels for All-Weather Atmospheric Water Harvesting. Advanced Materials 31, 1806446.
(24) Li, R., Shi, Y., Alsaedi, M., Wu, M., Shi, L., and Wang, P. (2018). Hybrid Hydrogel with High Water Vapor Harvesting Capacity for Deployable Solar-Driven Atmospheric Water Generator. Environmental Science & Technology 52, 11367-11377.
(25) Kallenberger, P. A., and Froba, M. (2018) Water harvesting from air with a hygroscopic salt in a hydrogel-derived matrix. Communications Chemistry 1, 28-28.
(26) Yao, H., Zhang, P., Huang, Y., Cheng, H., Li, C., and Qu, L. (2020). Highly Efficient Clean Water Production from Contaminated Air with a Wide Humidity Range. Advanced Materials 32, 1905875.
(27) Yang, K., Shi, Y., Wu, M., Wang, W., Jin, Y., Li, R., Shahzad, M. W., Ng, K. C., and Wang, P. (2020). Hollow spherical SiO2 micro-container encapsulation of LiCl for high-performance simultaneous heat reallocation and seawater desalination. Journal of Materials Chemistry A 8, 1887-1895.
(28) Li, R., Shi, Y., Shi, L., Alsaedi, M., and Wang, P. (2018). Harvesting Water from Air: Using Anhydrous Salt with Sunlight. Environmental Science & Technology 52, 5398-5406.
(29) Zhou, X., Lu, H., Zhao, F., and Yu, G. (2020). Atmospheric Water Harvesting: A Review of Material and Structural Designs. ACS Materials Letters 2, 671-684.
(30) Xu, Z., Zhang, L., Zhao, L., Li, B., Bhatia, B., Wang, C., Wilke, K. L., Song, Y., Labban, O., Lienhard, J. H., Wang, R., and Wang, E. N. (2020). Ultrahigh-efficiency desalination via a thermally-localized multistage solar still. Energy & Environmental Science 13, 830-839.
(31) Chiavazzo, E., Morciano, M., Viglino, F., Fasano, M., and Asinari, P. (2018). Passive solar high-yield seawater desalination by modular and low-cost distillation. Nature Sustainability 1, 763-772.
(32) Teo, H. W. B., Chakraborty, A., and Han, B. (2017). Water adsorption on CHA and AFI types zeolites: Modelling and investigation of adsorption chiller under static and dynamic conditions. Applied Thermal Engineering 127, 35-45.
(33) Teo, H. W. B., Chakraborty, A., and Fan, W. (2017). Improved adsorption characteristics data for AQSOA types zeolites and water systems under static and dynamic conditions. Microporous and Mesoporous Materials 242, 109-117.
(34) Kayal, S., Baichuan, S., and Saha, B. B. (2016). Adsorption characteristics of AQSOA zeolites and water for adsorption chillers. International Journal of Heat and Mass Transfer 92, 1120-1127.
(35) Narayanan, S., Yang, S., Kim, H., and Wang, E. N. (2014). Optimization of Adsorption Processes for Climate Control and Thermal Energy Storage. International Journal of Heat and Mass Transfer 77, 288-300.
(36) LaPotin, A., Kim, H., Rao, S. R., and Wang, E. N. (2019). Adsorption-Based Atmospheric Water Harvesting: Impact of Material and Component Properties on System-Level Performance. Accounts of Chemical Research 52, 1588-1597.
(37) Duffle, J. A., and Beckman, W. A. (2013). Solar Engineering of Thermal Processes. 4 ed. (John Wiley & Sons, Inc.)
(38) Zhao, L., Bhatia, B., Yang, S., Strobach, E., Weinstein, L. A., Cooper, T. A., Chen, G., and Wang, E. N. (2019). Harnessing Heat Beyond 200° C. from Unconcentrated Sunlight with Nonevacuated Transparent Aerogels. ACS Nano 13, 7508-7516.
(39) Nayak, P. K., Mahesh, S., Snaith, H. J., and Cahen, D. (2019). Photovoltaic solar cell technologies: analysing the state of the art. Nature Reviews Materials 4, 269-285.
(40) Mulchandani, A., and Westerhoff, P. (2020). Geospatial Climatic Factors Influence Water Production of Solar Desiccant Driven Atmospheric Water Capture Devices. Environmental Science & Technology 54, 8310-8322.
(41) de Lange, M. F., Verouden, K. J. F. M., Vlugt, T. J. H., Gascon, J., and Kapteijn, F. (2015). Adsorption-Driven Heat Pumps: The Potential of Metal-Organic Frameworks. Chemical Reviews 115, 12205-12250.
(42) Ranut, P. (2016). On the effective thermal conductivity of aluminum metal foams: Review and improvement of the available empirical and analytical models. Applied Thermal Engineering 101, 496-524.
(43) Skibinski, J., Cwieka, K., Haj Ibrahim, S., and Wejrzanowski, T. (2019). Influence of Pore Size Variation on Thermal Conductivity of Open-Porous Foams. Materials (Basel, Switzerland) 12, 2017.
(44) Hollands, K. G. T., Unny, T. E., Raithby, G. D., and Konicek, L. (1976). Free Convective Heat Transfer Across Inclined Air Layers. Journal of Heat Transfer 98, 189-193.
(45) Agency, U. S. E. P. (2018). 2018 Edition of the Drinking Water Standards and Health Advisories Tables. Office of Water U.S. EPA: Washington, D.C.

Other embodiments are within the scope of the following claims.

What is claimed is:

1. A water-harvesting system comprising:
a heat absorber;
a condenser opposite the solar absorber; and
two or more sorbent layers, each having a condenser surface, disposed between the solar absorber and the condenser.

2. The water-harvesting system of claim 1, further comprising a gap between the two or more adsorbent layers.

3. The water-harvesting system of claim 2, wherein each of the two or more sorbent layers include a metallic foam and a sorbent material.

4. The water-harvesting system of claim 3, wherein the sorbent material is a metal-organic framework, molecular sieve, a silica gel, a zeolite, a carbon fiber, activated carbon, a hygroscopic salt, hydrogel, an adsorbent material, an absorbent material, or combinations thereof.

5. The water-harvesting system of claim 3, wherein the sorbent material includes an iron aluminophosphate zeolite.

6. The water-harvesting system of claim 1, wherein each condenser surface includes a metal sheet in thermal contact with a sorbent material.

7. The water-harvesting system of claim 1, further comprising an enclosure containing the heat absorber, the two or more sorbent layers and the condenser.

8. The water-harvesting system of claim 1, wherein a packing porosity of one of the two or more the sorbent layers is between 0.4 and 0.8.

9. The water-harvesting system of claim 1, wherein each of the two or more sorbent layers has a thickness of between 0.5 mm and 30 mm.

10. The water-harvesting system of claim 1, wherein the system is powered by solar irradiance, biomass gasification, combustion, or electrically powered joule heating.

11. A method of water-harvesting comprising:
absorbing water from ambient atmosphere into a sorbent material;
applying energy to an energy absorber to desorb vapor, wherein two or more sorbent layers each including the sorbent material and a condenser surface are disposed between the energy absorber and a condenser; and
collecting water with the condenser.

12. The method of claim 11, further comprising a gap between the two or more sorbent layers.

13. The method of claim 11, further comprising dissipating heat from the condenser through a heat sink or active cooling.

14. The method of claim 11, further comprising dissipating heat from a condenser surface to an adjacent sorbent layer.

15. The method of claim 11, wherein applying energy includes supplying solar irradiance, biomass gasification, combustion, or electrically powered joule heating.

16. The method of claim 11, further comprising an enclosure containing the two or more sorbent layers and the condenser.

17. The method of claim 16, wherein the enclosure is opened during dark periods for water adsorption and the enclosure is closed during light periods for water production.

18. The method of claim 16, wherein the two or more sorbent layers exchange into the enclosure prior to desorbing water.

19. The method of claim 11, wherein the vapor moves from the sorbent layer to the condenser following a concentration gradient.

20. The method of claim 11, wherein the sorbent material is a metal-organic framework, molecular sieve, a silica gel, a zeolite, a carbon fiber, activated carbon, a hygroscopic salt, hydrogel, an adsorbent material, an absorbent material, or combinations thereof.

21. The method of claim 11, wherein the sorbent material includes an iron aluminophosphate zeolite.
